(19) United States
(12) Patent Application Publication
(10) Pub. No.: US 2011/0241374 A1
(43) Pub. Date: Oct. 6, 2011

(54) VEHICLE FLOORBOARD STORAGE

(76) Inventor: Delray Graves, Washington, UT (US)

(21) Appl. No.: 12/895,837

(22) Filed: Sep. 30, 2010

Related U.S. Application Data
(63) Continuation-in-part of application No. 12/060,147, filed on Mar. 31, 2008.

(51) Int. Cl. B60N 3/06

(52) U.S. Cl. 296/75

(57) ABSTRACT

A vehicle footrest, such as a floorboard or footpeg, comprising a container or compartment adapted for attaching to a vehicle, such as a motorcycle or other recreational vehicle, is disclosed. The footrest may be used to support a rider's foot and ankle, while providing a rider with a convenient container for carrying items, such as tools or personal property. The footrest may include a first part and a second part. The first part may include a top surface that may support the rider's foot. The first part may be attached to the second part, which may be substantially hollow, with a hinge to thereby form a container or compartment that can be opened and closed. The container or compartment may be attached to the vehicle with a mounting assembly that may accommodate numerous styles and makes of vehicles.

### CROSS-REFERENCE TO RELATED APPLICATIONS

This patent application is a continuation-in part-of U.S. patent application Ser. No. 12/060,147 filed on Mar. 31, 2008, which is hereby incorporated by reference herein in its entirety, including but not limited to those portions that specifically appear hereinafter, the incorporation by reference being made with the following exception: In the event that any portion of the above-referenced application is inconsistent with this application, this application supercedes said above-referenced application.

### STATEMENT REGARDING FEDERALLY SPONSORED RESEARCH OR DEVELOPMENT

Not Applicable.

### BACKGROUND

1. The Field of the Disclosure

The disclosure relates generally to vehicle footrests, and more particularly, but not necessarily entirely, to a device that may be used as a footrest and a container for storage for motorcycles or recreational vehicles.

2. Summary of the Disclosure

Riders of motorcycles and other recreational vehicles typically sit astride the vehicle on a saddle at a comfortable arm's length from a handle bar that provides the rider with the ability to steer motorcycle or other recreational vehicle in a desired manner. The rider's feet are traditionally supported by footrests while in a seated position. Generally, there are two different types of footrests for motorcycles and other recreational vehicles, namely footpegs and floorboards.

Footpegs are short shafts that typically extend outwardly from a vehicle frame in a lateral direction. Footpegs are commonly used and are the most widely used footrest because footpegs traditionally are simple in operation and design and function very well. Further, footpegs having a stirrup have become increasingly popular because of the heel rest that extends from the shaft of the peg can provide added comfort and support for the heel of the rider's foot.

On the other hand, floorboards provide a motorcycle or recreational vehicle rider with a different foot support than the traditional footpeg. Floorboards may provide a flat, upwardly-sloped surface that faces the rider and operates to support both the sole and heel portion of the rider's shoe or boot. Floorboards are generally known to provide greater rider comfort because the floorboard is a solid surface that constitutes a fixed angle to complement and support the rider's ankle and foot.

In contrast, a rider's shoe or boot can rotate about a footpeg, requiring more effort on the part of the rider to hold the foot in a fixed position. Floorboards are often used with cruisers, choppers, and touring motorcycles and provide a certain distinguishable look and comfort for a rider. It will be appreciated that both footpegs and floorboards have their own distinct advantages.

Further, it will be appreciated that motorcycles and other recreational vehicles are mechanical devices that require maintenance. On occasion, a particular motorcycle or recreational vehicle may require some form of maintenance when a rider is using the vehicle, which may have become apparent during use or otherwise. Many motorcycles and other recreational vehicles are equipped with compartments or containers for carrying personal items or other property, including tools for on the road maintenance.

Motorcycles and other recreational vehicles may be equipped with hard or leather saddle bags, sissy bar bags, tool bags, trunks or other containers. Many of these containers are located on the outer dimensions of the back end of the motorcycle and these containers may be considered by some riders to be bulky and unattractive. The containers or compartments may even be located under the saddle of the motorcycle in the area of the motorcycle traditionally reserved for the air box. In those instances, the container or compartment may be effecting the mechanics of the motorcycle because the air box must be shifted to another area to accommodate the container or compartment.

Despite the advantages of known containers and compartments for motorcycles and other recreational vehicles, improvements are still being sought. However, containers and compartments on the market are characterized by several disadvantages that may be addressed by the disclosure. The disclosure minimizes, and in some aspects eliminates, the failures and inadequacies of the containers and compartments known on the market, and other problems, by utilizing the methods and structural features described herein.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out in the appended claims.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The container portion may be pivotally connected to the lid portion, such that the lid portion is rotatable relative to the container portion thereby providing access to the interior volume of the floorboard.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The lid portion may be removably attached to the container portion, such that the lid portion is removable from the container portion thereby providing access to the interior volume of the floorboard.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The lid portion may be removably and pivotally attached to the container portion, such that the lid portion is removable and rotatable relative to the container portion thereby providing access to the interior volume of the floorboard.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The bracket may be attached to the container portion with a fastener that is operable from inside of the container portion.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise a magnet associated with said lid portion for magnetically attracting tools and parts thereto.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise a weather tight seal, sealing the lid portion and the container portion.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise a lock, for locking the lid portion and the container portion.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise an insert for holding items in place within the container portion.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise an insert for holding items in place within the container portion, wherein said insert comprises recesses therein configured to accommodate electronic devices therein.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise an opening therein for allowing electrical wiring to pass therethrough.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise electrical connectivity.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise a lock, for locking the lid portion and the container portion, wherein the lock is keyed so as to operable with a key the operates said vehicle upon which the floorboard is attached.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise a hidden hinge connecting said lid portion to said container portion such that the hinge can only be accessed from within said container portion.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise a tool therein corresponding to the vehicle upon which the floorboard is attached.

An embodiment of a floorboard for exterior mounting on a vehicle may comprise a container portion comprising an interior volume configured for storage. The floorboard may also comprise a lid portion sized and shaped to cover said container portion, wherein said lid portion further comprises a substantially flat surface that is configured to support a user's foot, and a bracket for mounting to a vehicle. The floorboard may further comprise a lock, for locking the lid portion and the container portion, wherein the lock may further comprise a cover for concealing and protecting an opening of said lock.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise a plurality of tools corresponding to the vehicle upon which the floorboards are mounted.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The removable inserts may be customizable by a user.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The container portion may be pivotally connected to the lid portion, such that the lid portion is rotatable relative to the container portion thereby providing access to the interior volume of the floorboard.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The lid portion may be removably attached to the container portion, such that the lid portion is removable from the container portion thereby providing access to the interior volume of the floorboard.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The lid portion may be removably and pivotally attached to the container portion, such that the lid portion is removable and rotatable relative to the container portion thereby providing access to the interior volume of the floorboard.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The bracket may be attached to the container portion with a fastener that is operable from inside of the container portion.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise a magnet associated with said lid portion for magnetically attracting tools and parts thereto.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise a weather tight seal, sealing the lid portion and the container portion.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise a lock, for locking the lid portion and the container portion.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise an insert for holding items in place within the container portion.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise an insert for holding items in place within the container portion, wherein said insert comprises recesses therein configured to accommodate electronic devices therein.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise an opening therein for allowing electrical wiring to pass therethrough.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise electrical connectivity.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise a lock, for locking the lid portion and the container portion, wherein the lock is keyed so as to operable with a key the operates said vehicle upon which the floorboard is attached.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise a hidden hinge connecting said lid portion to said container portion such that the hinge can only be accessed from within said container portion.

An embodiment of a floorboard kit for exterior mounting on a vehicle may comprise a pair of floorboards wherein each floorboard comprises: a container portion comprising an interior volume configured for storage; a lid portion sized and shaped to cover said container portion, wherein said lid portion further comprises a substantially flat surface that is configured to support a user's foot; and a bracket for mounting to a vehicle. The kit may also comprise a plurality of removable inserts. The kit may further comprise a tool therein corresponding to the vehicle upon which the floorboard is attached.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of a vehicle footrest in a partially opened position made in accordance with the principles of the disclosure;

FIG. 2 is a perspective view of a vehicle footrest in a closed position made in accordance with the principles of the disclosure;

FIG. 3 is a perspective view of a vehicle footrest in an opened position made in accordance with the principles of the disclosure;

FIG. 4 is a top view of a vehicle footrest in a closed position made in accordance with the principles of the disclosure;

FIG. 5 is side view of a vehicle footrest in a closed position made in accordance with the principles of the disclosure;

FIG. 6 is a front view of a vehicle footrest in a closed position made in accordance with the principles of the disclosure;

FIG. 7 is a perspective, side view of a vehicle footrest in a closed position made in accordance with the principles of the disclosure;

FIG. 8 is a perspective, side view of a vehicle footrest in a partially opened position made in accordance with the principles of the disclosure;

FIG. 9 is a side view of a vehicle footrest in a partially opened position made in accordance with the principles of the disclosure;

FIG. 10 is a front view of a vehicle footrest in a partially opened position made in accordance with the principles of the disclosure;

FIG. 11 is an exploded view of a vehicle footrest illustrating a first part, an insert, a second part, and a mounting structure in accordance with the principles of the disclosure;

FIG. 12 is a view of a vehicle floorboard as mounted on a vehicle made in accordance with the principles of the disclosure;

FIG. 13 is a view of a vehicle floorboard as mounted on a vehicle in a varied configuration made in accordance with the principles of the disclosure;

FIG. 14 illustrates a floorboard made in accordance with the principles of the disclosure;

FIG. 15 illustrates a floorboard made in accordance with the principles of the disclosure;

FIG. 16 illustrates a rear view of a floorboard made in accordance with the principles of the disclosure;

FIG. 17 illustrates a vehicle side view of floorboard made in accordance with the principles of the disclosure;

FIG. 18 illustrates a top view of a floorboard made in accordance with the principles of the disclosure;

FIG. 19 illustrates a bottom view of a floorboard made in accordance with the principles of the disclosure;

FIG. 20 illustrates an inside detailed view of a floorboard made in accordance with the principles of the disclosure;

FIG. 21 illustrates an inside detailed view of a floorboard made in accordance with the principles of the disclosure;

FIG. 22 illustrates an inside detailed view of a floorboard made in accordance with the principles of the disclosure;

FIG. 23 illustrates an inside detailed view of a floorboard having a hinge embodiment made in accordance with the principles of the disclosure;

FIG. 24 illustrates an inside detailed view of a floorboard having a hinge embodiment made in accordance with the principles of the disclosure;

FIG. 25 illustrates an inside detailed view of a floorboard made in accordance with the principles of the disclosure;

FIG. 26 illustrates an inside detailed view of a floorboard made in accordance with the principles of the disclosure;

FIG. 27 illustrates an inside detailed view of a floorboard having an insert made in accordance with the principles of the disclosure;

FIG. 28 illustrates an inside detailed view of a floorboard having an insert made in accordance with the principles of the disclosure;

FIG. 29 illustrates an inside detailed view of a floorboard having an insert made in accordance with the principles of the disclosure;

FIG. 30 illustrates an inside detailed view of a floorboard providing electrical connectivity with a device therein made in accordance with the principles of the disclosure;

FIG. 31 illustrates an embodiment of a floorboard having a releasable hinges made in accordance with the principles of the disclosure;

FIG. 32 illustrates an embodiment of a floorboard having a releasable hinges made in accordance with the principles of the disclosure;

FIG. 33 illustrates an embodiment of a floorboard having a releasable hinges made in accordance with the principles of the disclosure;

FIG. 34 illustrates an embodiment of a floorboard having magnetic functionality made in accordance with the principles of the disclosure;

FIG. 35 illustrates an embodiment of a floorboard having locking functionality made in accordance with the principles of the disclosure; and

FIG. 36 illustrates an embodiment of a floorboard having locking functionality made in accordance with the principles of the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the structural features of the floorboard container are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

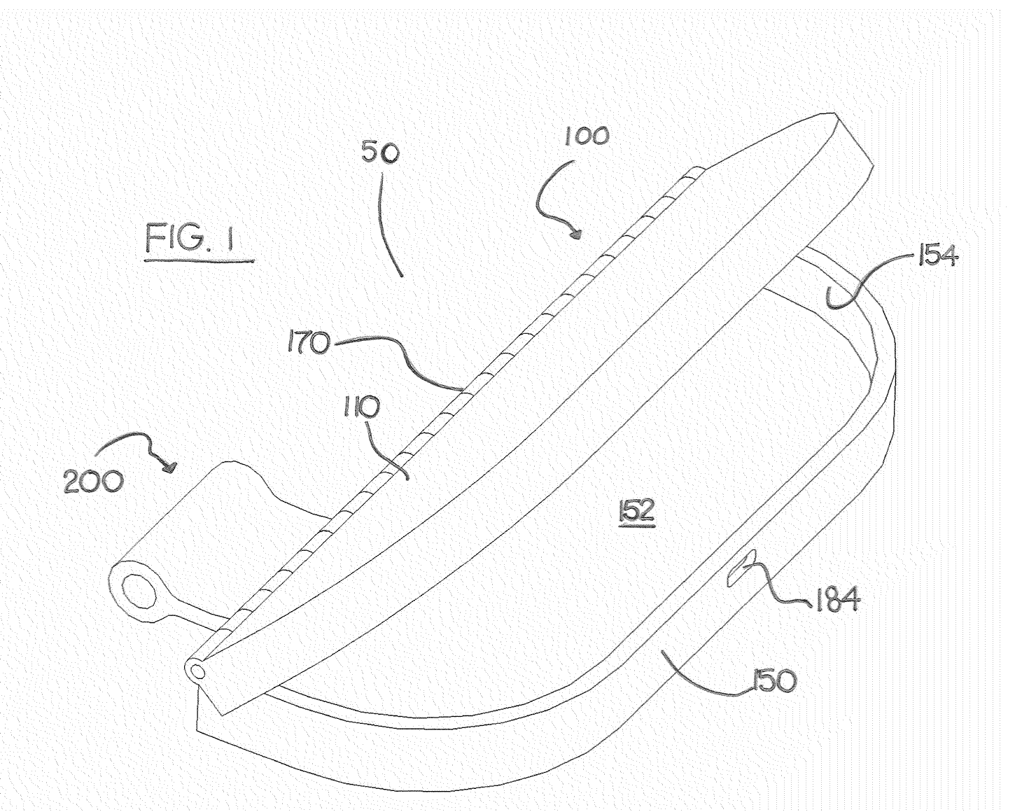

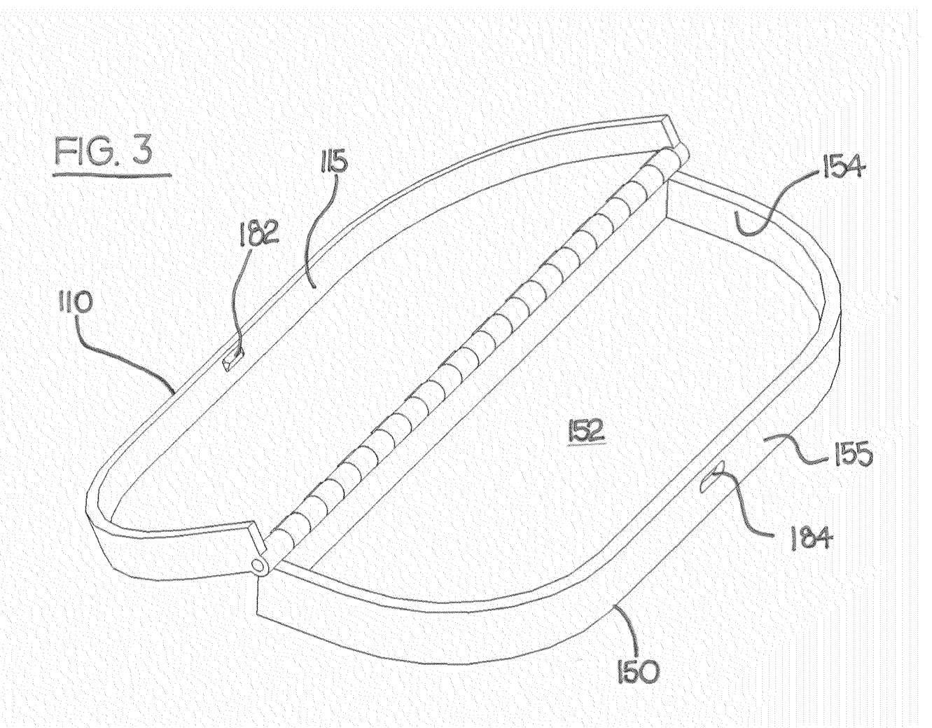

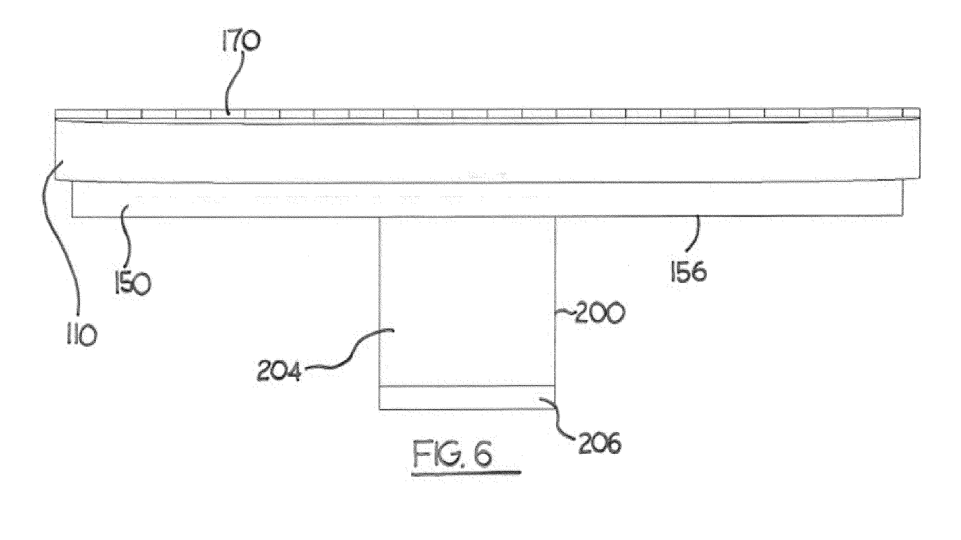

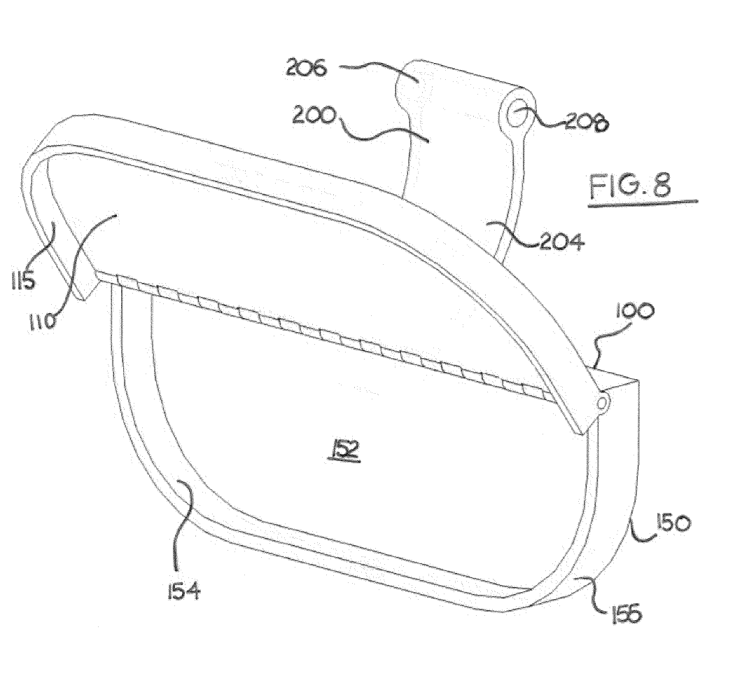

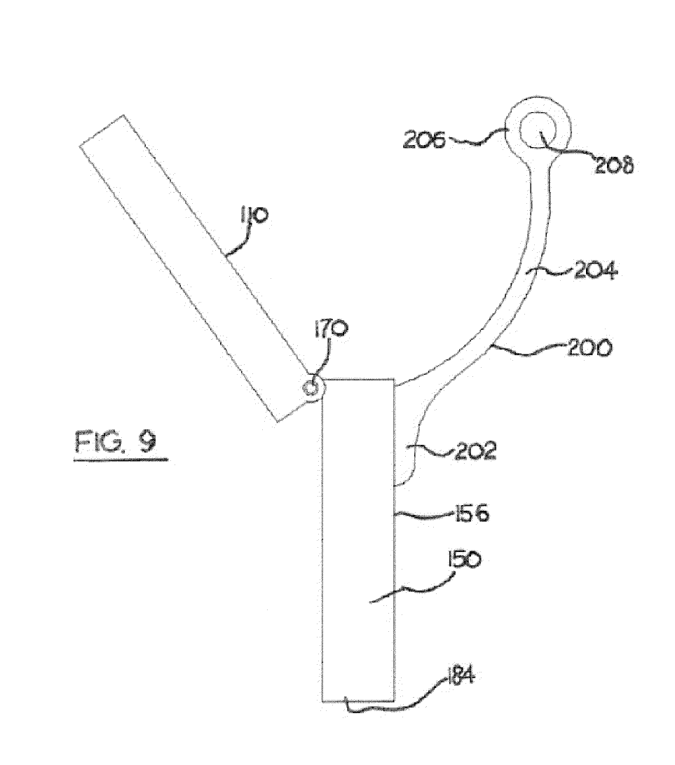

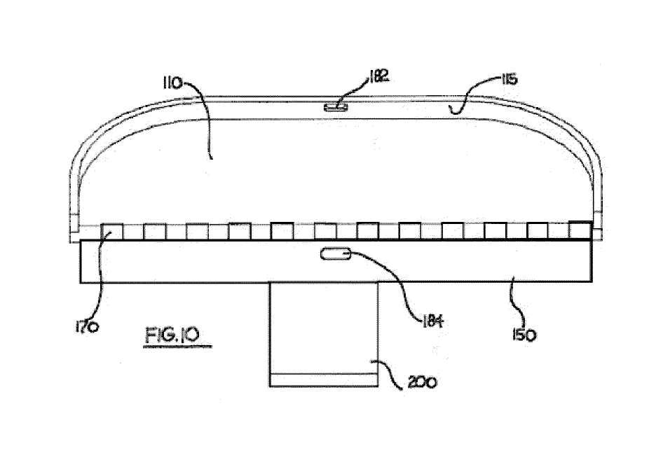

Referring now to FIGS. 1-36, the disclosure relates to a vehicle footrest kit 50 and a vehicle footrest 100. The kit may include the vehicle footrest 100 and a mounting structure 200 for connecting the footrest 100 to the vehicle 10. The footrest 100 may comprise a first part 110 having a first surface 112 and a second part 150 connectable to the first part 110. The second part 150 may comprise a substantially hollow interior 152 as best illustrated in FIGS. 1 and 3.

It will be appreciated that the substantially hollow interior 152 of the second part 150 may include a volume that may fall within a range of about K (21 cubic inches to 140 cubic inches). Alternatively, the volume of the substantially hollow interior 152 may be between a range of about K (12 cubic inches to 235 cubic inches). It is to be understood that all values falling within the ranges provided above are within the scope of the disclosure. It will be appreciated that K is a constant between 0.8 and 1.2 and may be used as a scaling factor to account for different sized footrests.

Further, the first surface 112 of the first part 110 may include a surface area that may fall within a range of about K (28 square inches to 75 square inches). Alternatively, the surface area of the first surface 112 may be between a range of about K (16 square inches to 98 square inches). It is to be understood that all values falling within the ranges provided above are within the scope of the disclosure. It will be appreciated that K is a constant between 0.8 and 1.2 and may be used as a scaling factor to account for different sized footrests.

Different sizes of footrests will of course be provided depending upon the size of the vehicle in connection with which the footrests will be used. However, since the footrests may be similarly shaped, the size and shape can be represented for all standard footrests together and can be adapted by a conversion or scaling factor K, which may specify the size ratio of the respective footrests and may be between 0.8 and 1.2.

An example of the dimensions of the footrest 100 may include a length dimension that may be within a range of about eight inches to about sixteen inches, a width dimension that may be within a range of about two inches to about seven inches, and a height or thickness dimension that may be within a range of about three-quarters of an inch to about three inches. It will be appreciated that all values falling within the ranges provided above are within the scope of the disclosure.

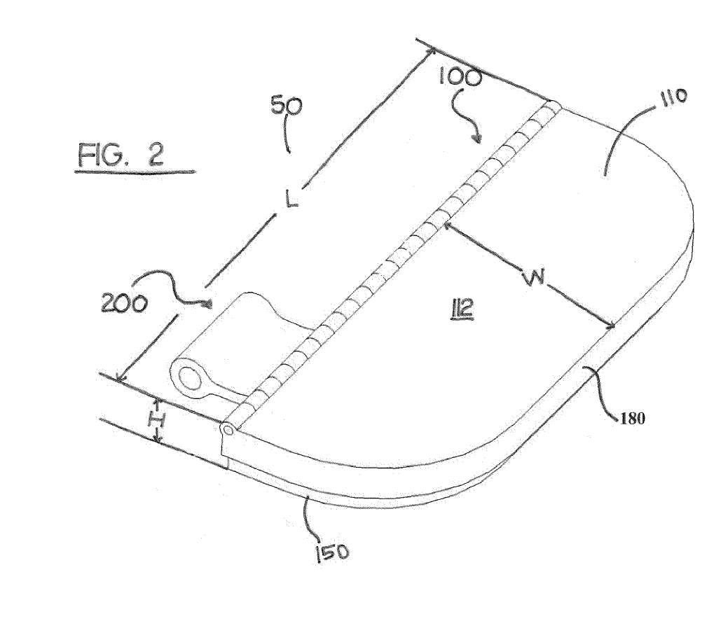

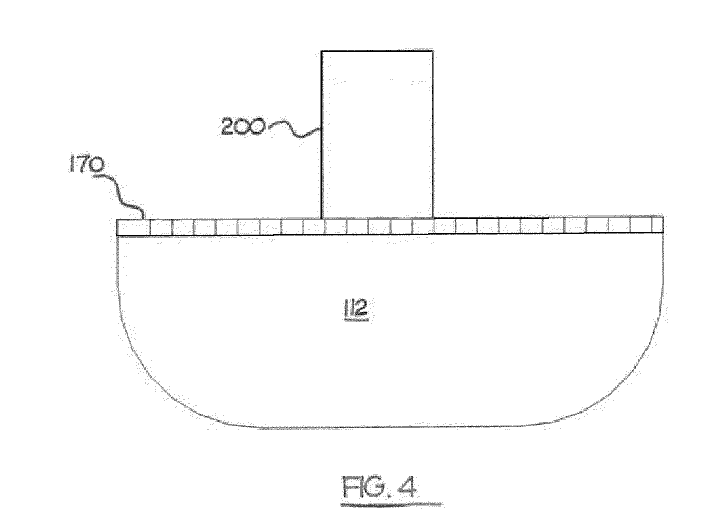

Referring now specifically to FIGS. 2 and 4, the first surface 112 may be a top surface of the first part 110 and may be configured and arranged for supporting a rider's foot. The top surface 112 may include a slip resistant mechanism 114. It will be understood that the slip resistant mechanism 114 may be any texture that is either part of the footrest 100 itself or that may be physically applied to the footrest 100, such as grooves, checkered patterns, or small protrusions extending from the first surface 112 of the footrest 100 to form a textured surface. It will be appreciated that the slip resistant mechanism 114 may also be an insert, whether made of rubber or another material, having an anti-slip pattern on the insert without departing from the spirit or scope of the disclosure. It will be appreciated that such slip resistant mechanisms 114 are well known in the art, and any such slip resistant mechanism known, or that may become known, in the art is intended to fall within the scope of the disclosure.

As best illustrated in FIGS. 1, 3 and 8, the second part 150 of the footrest 100 may comprise a sidewall 154 that may define the substantially hollow interior 152 or well 152. It will be appreciated that as used herein the terms “hollow interior” or “well” may be any recessed area or depression formed in a structural member. It will be appreciated that the hollow interior or well 152 may be used for holding any item or items, whether tools, personal property or otherwise.

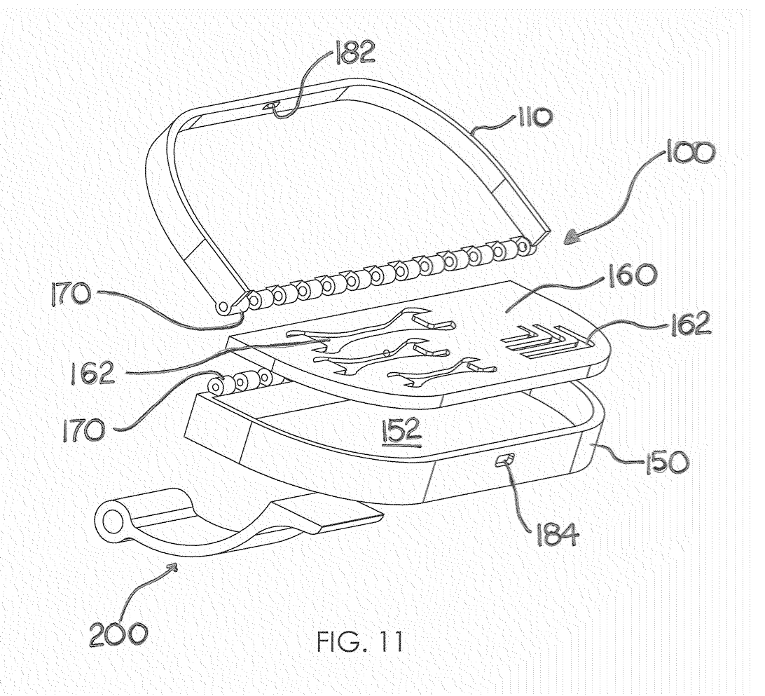

Referring briefly to FIG. 11, the second part 150 of the footrest 100 may comprise an insert 160, which may be a foam material, that may be sized and shaped to be located and secured within the substantially hollow interior or well 152 of the second part 150. The insert 160 may comprise a cutout 162 or, alternatively, a plurality of cutouts 162, each of which may be configured and adapted for holding or securing standard or metric sized tools. The insert 160 may also be used to hold and secure other items besides tools, such as personal property, without departing from the scope of the disclosure. Thus, the insert 160 may operate to secure tools or other items in place within the footrest 100.

As illustrated in FIGS. 1-4 and 7-9, the first part 110 may be pivotally connected to the second part 150 of the footrest 100 by a hinge 170. The hinge 170 may be for example a stainless steel piano hinge, or the hinge 170 may be any other device that movably connects the first part 110 to the second part 150. It will be appreciated that the hinge device may be made from any suitable material, such as a metallic material or a hard polymeric material, without departing from the spirit or scope of the disclosure.

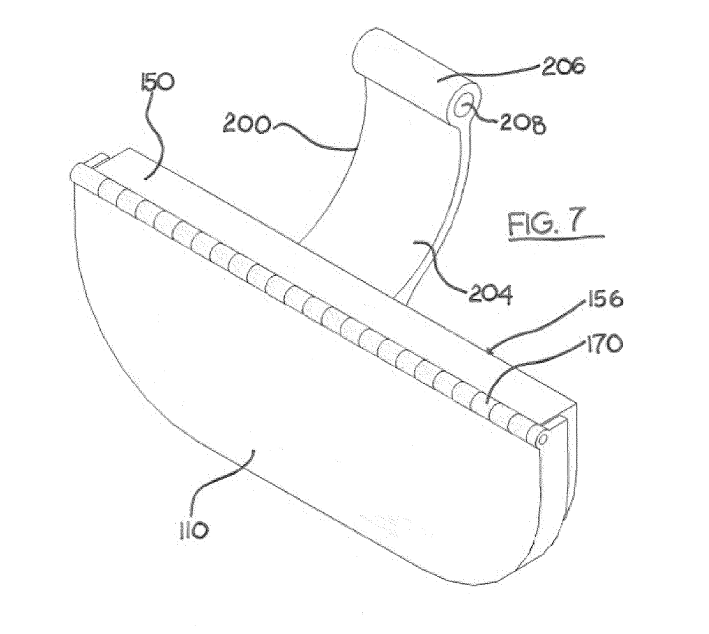

It is to be understood that the first part 110 may be movable with respect to the second part 150 of the footrest 100 and the first part 110 may be positioned in a plurality of positions with respect to the second part 150. For example, the first part 110 may be positioned in an open position (see FIGS. 1 and 3) and a closed position (see FIGS. 2 and 7).

It will be understood that the footrest 100 itself may be a driver's footrest or a passenger's footrest. Further, the footrest 100 may be manufactured for each side of the vehicle, whether the vehicle is a motorcycle or some other recreational vehicle. The footrest 100 may be either a footpeg or a floorboard without departing from the spirit or scope of the disclosure.

Referring now to FIGS. 1, 3, 6, 10 and 11, the footrest 100 may comprise a closure 180 for holding the first part 110 and the second part 150 together to form a substantially closed container. The closure 180 may be comprised of a protrusion 182 and a corresponding recess 184. The protrusion 182 may be located on an inner lip or inside portion 115 of the first part 110. The recess 184, on the other hand, may be located on an outer portion 155 of the sidewall 154 of the second part 150 (illustrated best in FIG. 3). It will be appreciated that the protrusion 182 may matingly engage the recess 184 when the first part 110 is in a closed position with respect to the second part 150. The protrusion 182 may be sized large enough to clasp the recess 184, but small enough to be unclasped from the recess 184 and thereby allowed to open. It will be appreciated that any closure 180 known, or that may become known, in the art for securing a first part 110 to a second part 150 in a closeable position may be utilized without departing from the spirit or scope of the disclosure.

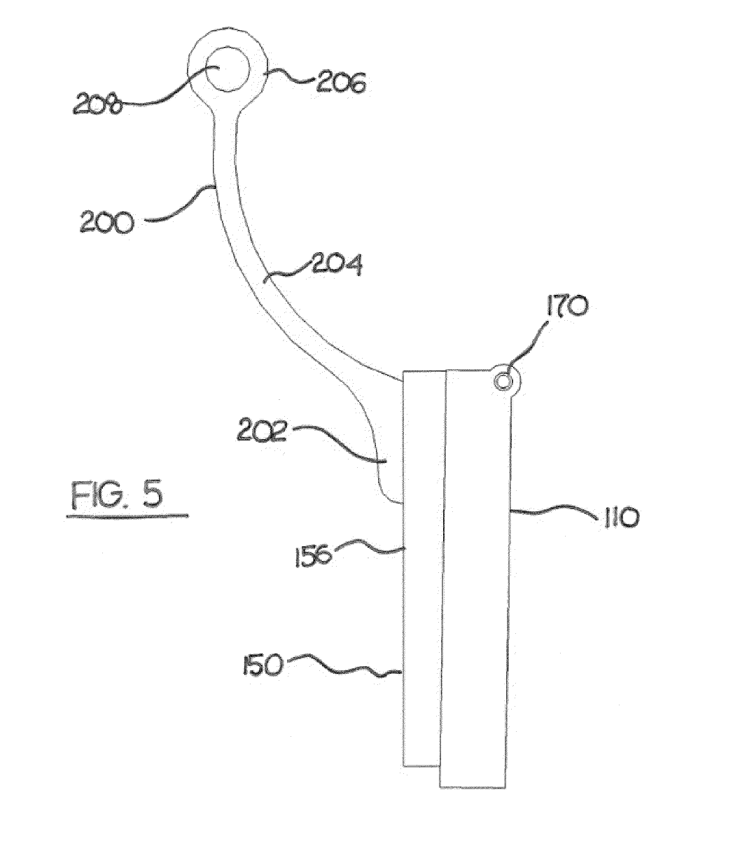

Referring now to FIGS. 1, 2, 5, 7, 9 and 11, the kit 50 may further comprise a mounting structure 200. The mounting structure 200 may be a universal mount that may be attached to a number of different vehicle makes and types, or the mounting structure 200 may be a specifically crafted or manufactured mount that is specific to a vehicle make and type. As illustrated best in FIG. 5, the mounting structure 200 may be secured to a bottom surface 156 of the second part 150 of the footrest 100. The mounting structure 200 may be attached to the bottom surface 156 of the second part 150 in a variety of ways that are known in the art, for example, with nuts and bolts, a weld, or other fasteners, or by way of fasteners that may become known in the future in the art, without departing from the spirit and scope of the disclosure.

As illustrated best in FIG. 5, the mounting structure 200 may include a base 202 that may operate to attach the mounting structure 200 to the bottom surface 156 of the second part 150. An arm 204 extend outwardly from the base 202. The arm 204 may terminate at a head 206. The head 206 may comprise an opening 208 extending therethrough to permit a fastener (not shown) to attach the head 206 of the mounting structure 200 to the vehicle, such as a motorcycle or other recreational vehicle.

It will be appreciated that the footrest 100, including the first part 110 and the second part 150, may be made or manufactured from a billet of aluminum or aluminum alloy. More specifically, the footrest 100 of the disclosure may be milled from aluminum or aluminum alloy. It will be appreciated that since pure aluminum is a relatively ductile metal, an aluminum alloy may be used, such as 6061-T6 aluminum, which is a lighter, stronger, more corrosion-resistant than pure aluminum and may be better suited for motorcycles and other recreational vehicles. It will be appreciated that other metals and non-metallic materials, such as ceramics or polymers, may be used as an alternative to aluminum, without departing from the spirit or scope of the disclosure. Further, while it may be advantageous to mill the footrest 100 or container from a block of aluminum or aluminum alloy, other manufacturing methods may be used, for example die-casting, where a metallic material may be heated and punched to shape and size creating a work hardened surface with predetermined characteristics.

In accordance with the features and combinations described above, a useful method of making a vehicle footrest may comprise the steps of:

(a) forming a vehicle footrest comprising a first part having a first surface configured and arranged for supporting a rider's foot and a second part comprising a substantially hollow interior; and

(b) connecting the first part to the second part, such that the first part is movable with respect to the second part and may be positioned in a plurality of positions, including an open position and a closed position;

wherein a volume of the substantially hollow interior of the second part is K (21 cubic inches to 140 cubic inches) and a surface area of the first surface of the first part is K (28 square inches to 70 square inches);

wherein K is a constant between 0.8 and 1.2.

Those having ordinary skill in the relevant art will appreciate the advantages provide by the features of the disclosure. For example, it is a potential feature of the disclosure to provide a vehicle footrest kit comprising a footrest and a mounting structure that is simple in design and manufacture. It is a potential feature of the disclosure to provide a hollow interior in the footrest for storage of items, such as tools or other personal property. Another potential feature of the disclosure is to provide such a footrest that includes a hinged connection, such that one side of the footrest is capable of opening and closing easily with respect to the opposite side to allow a rider access to the items stored within the footrest. It is another potential feature of the disclosure to provide such a footrest for the right and left hand side of a vehicle and to provide a driver's footrest or a passenger's footrest. It is another potential feature of the disclosure to provide an insert, which may be a foam material, that may be sized and shaped to be located and secured within the substantially hollow interior of the footrest. It is another potential feature of the disclosure to provide such a footrest that is made from aluminum or aluminum alloy, other metallic or non-metallic materials.

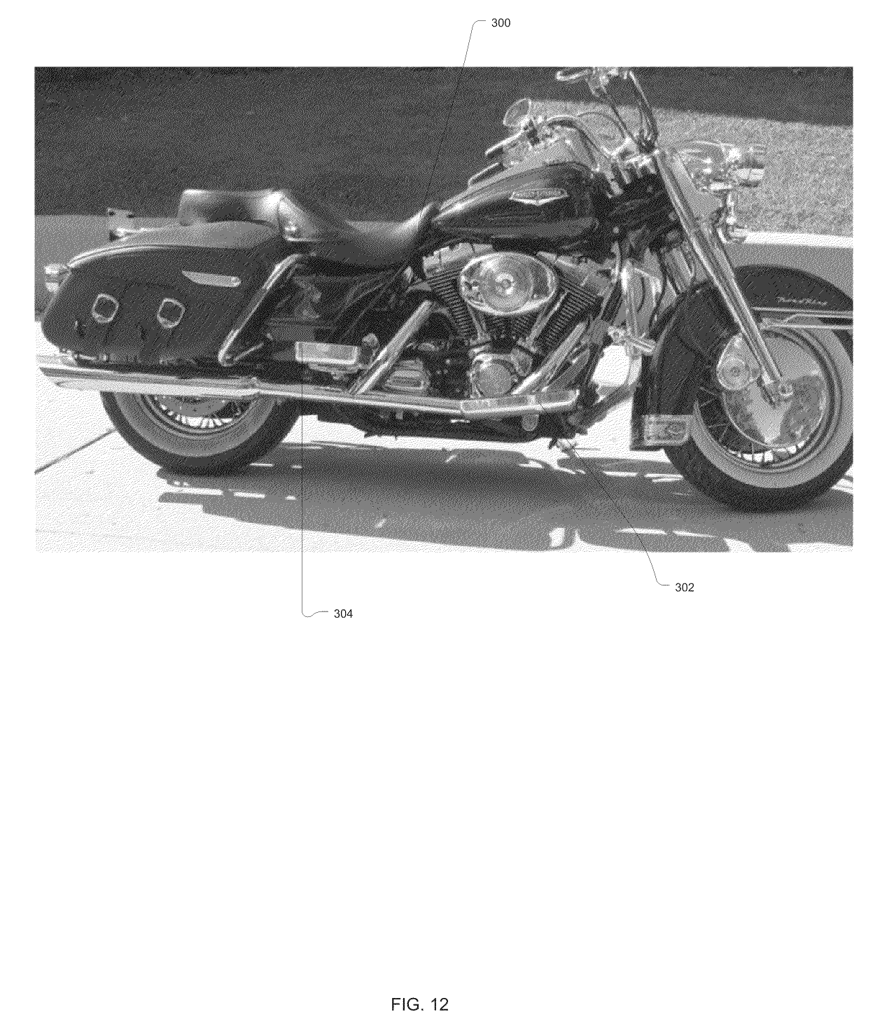

FIG. 12 illustrates an embodiment of a vehicle floorboard 302 and 304 as mounted on a vehicle 300. As can be seen in the illustration floorboard 302 may be utilized by a primary rider as a footrest, while passenger floorboard 304 may be utilized by a passenger.

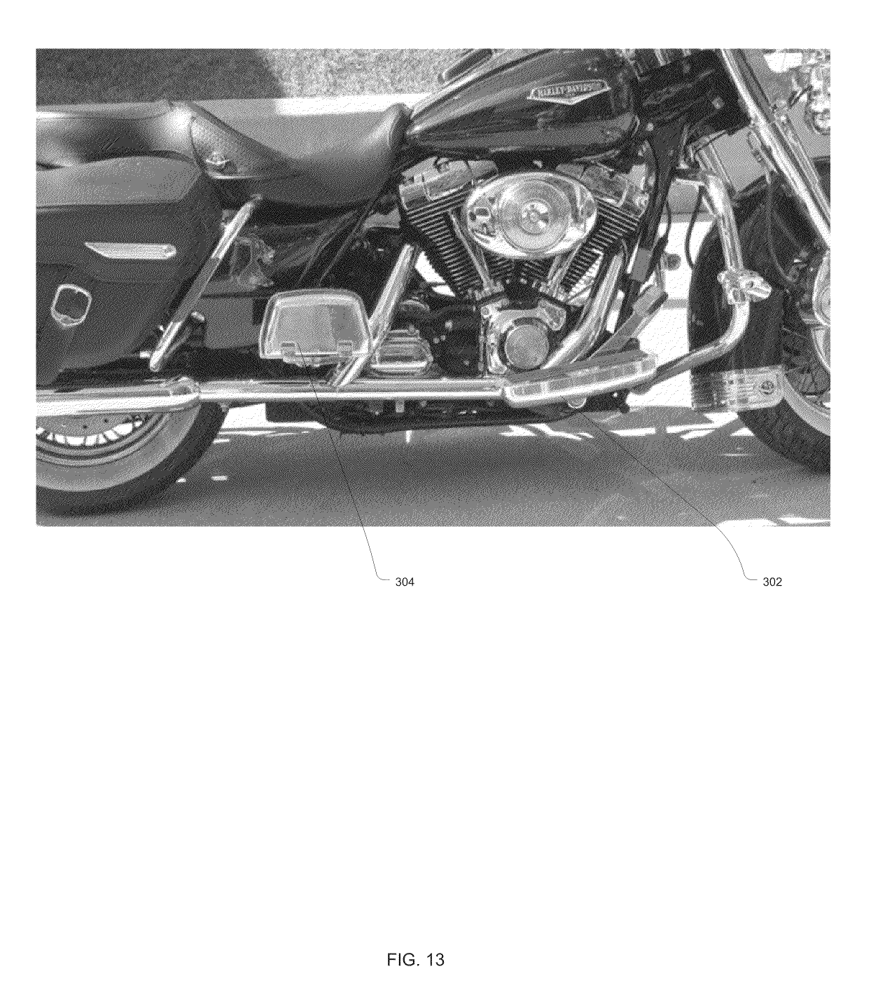

FIG. 13 is a view of a vehicle floorboard as mounted on a vehicle in a varied configuration. As can be seen in the illustration passenger floorboard 304 may be folded up out of the way. Consistent with the disclosure, the floorboards 302 and 304 may utilize the existing brackets on the vehicle for mounting. In an embodiment specialized brackets may be used for mounting the floorboards to vehicles of differing configurations. A kit may include floorboards and brackets, or the brackets may be obtained independently.

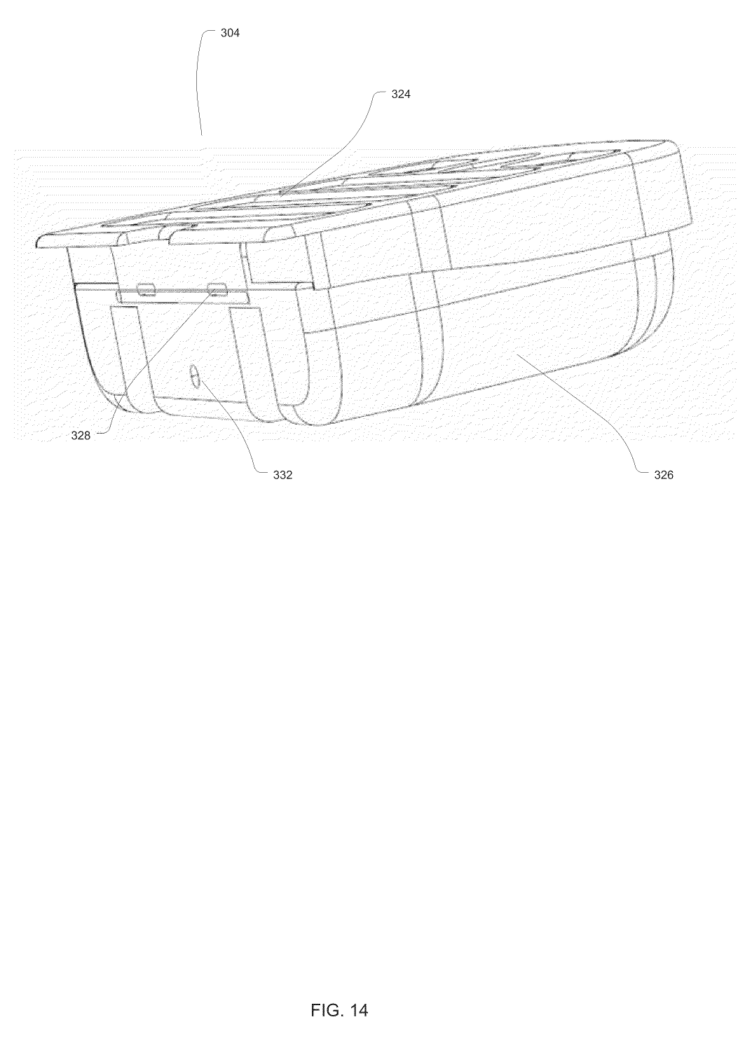

FIG. 14 illustrates a floorboard 304 in greater detail. An embodiment of a floorboard 304 may comprise a lid portion 324 and a container portion 326. The container portion 326 provides a volume for storage while the lid portion 324 substantially covers the volume and therefore covers and retains any items stored in the floorboard 304. The floorboard 304 may further comprise hinge 328. The hinge 328 may be hidden so as not to be tampered with. The hinge 328 could also allow the lid portion 324 to be removed from the container portion 326 with out the use of tools. The container portion may also comprise mounting structures such as the fastener opening.

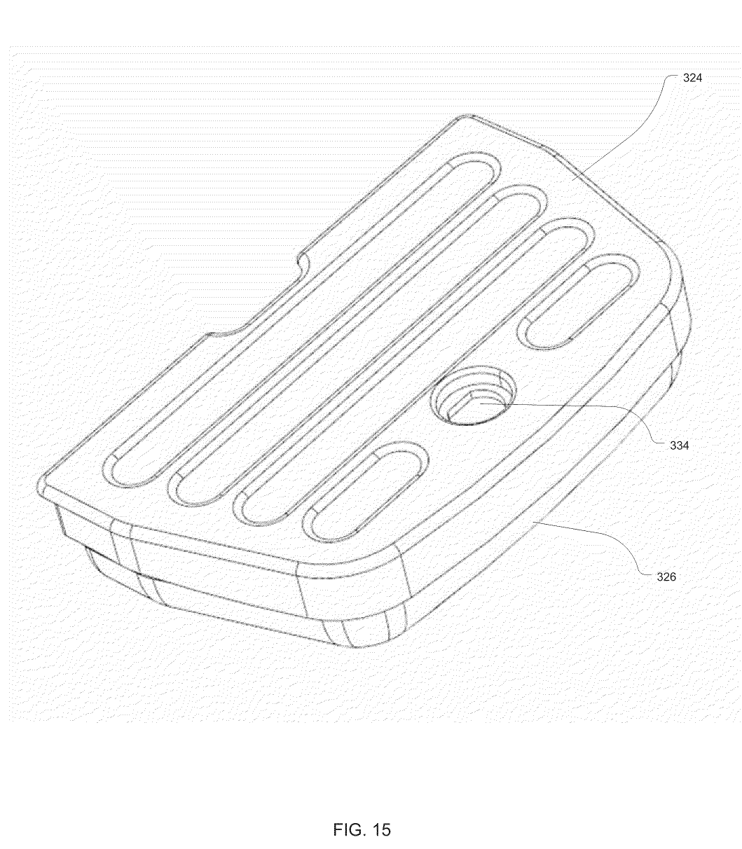

FIG. 15 illustrates a floorboard 304 providing greater detail of the top of the lid portion 324. As can be seen in the figure the lid portion 324 may comprise a textured portion thereon. The lid portion may also comprise a lock opening 334 for accommodating a lock.

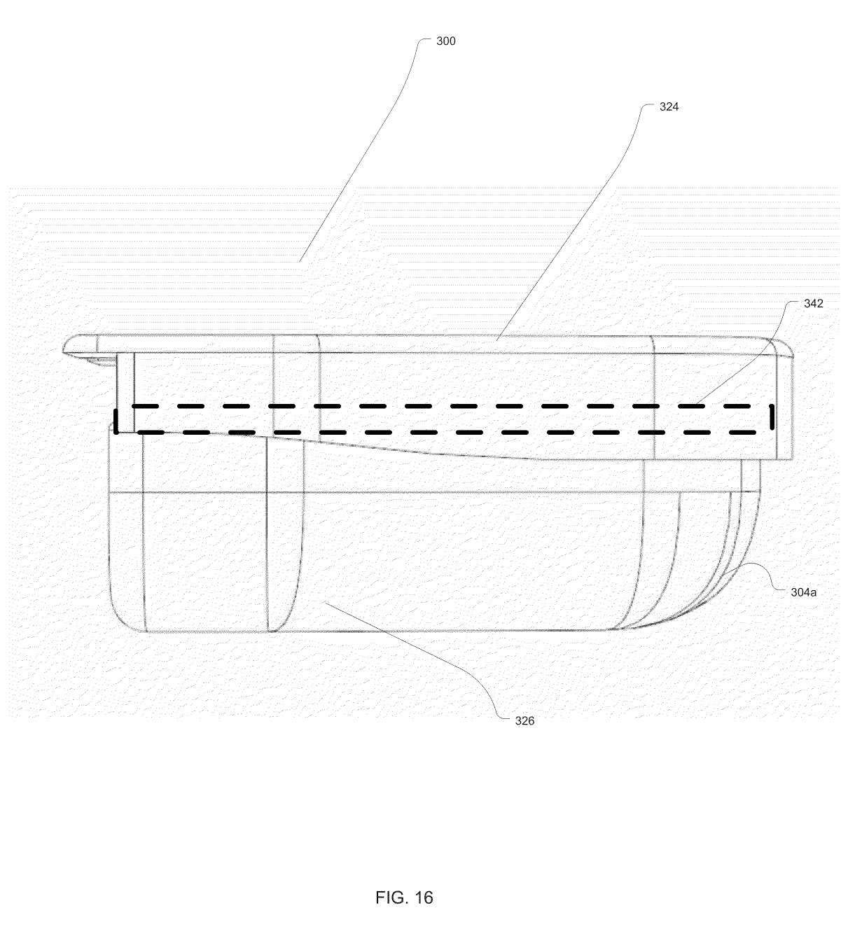

FIG. 16 illustrates a rear view of a floorboard 304 as would be seen from the back of a vehicle 300. As can be seen in the figure, the container portion 324 may be tapered or shaped toward the outer edge 304a to aid in cornering a vehicle 300 such as a motorcycle. Additionally, it can be seen in the figure that the lid portion 324 overlaps the container portion 326 thereby aiding in keeping dirt and moister out. In an embodiment a seal 342 (seen in dashed lines) may be used to provide further weather tightness. The seal 342 may be made of any suitable material and may be attached to either the lid portion 324 or the container portion 326. The seal 342 may be made of a deformable material to accommodate contours of the mating parts.

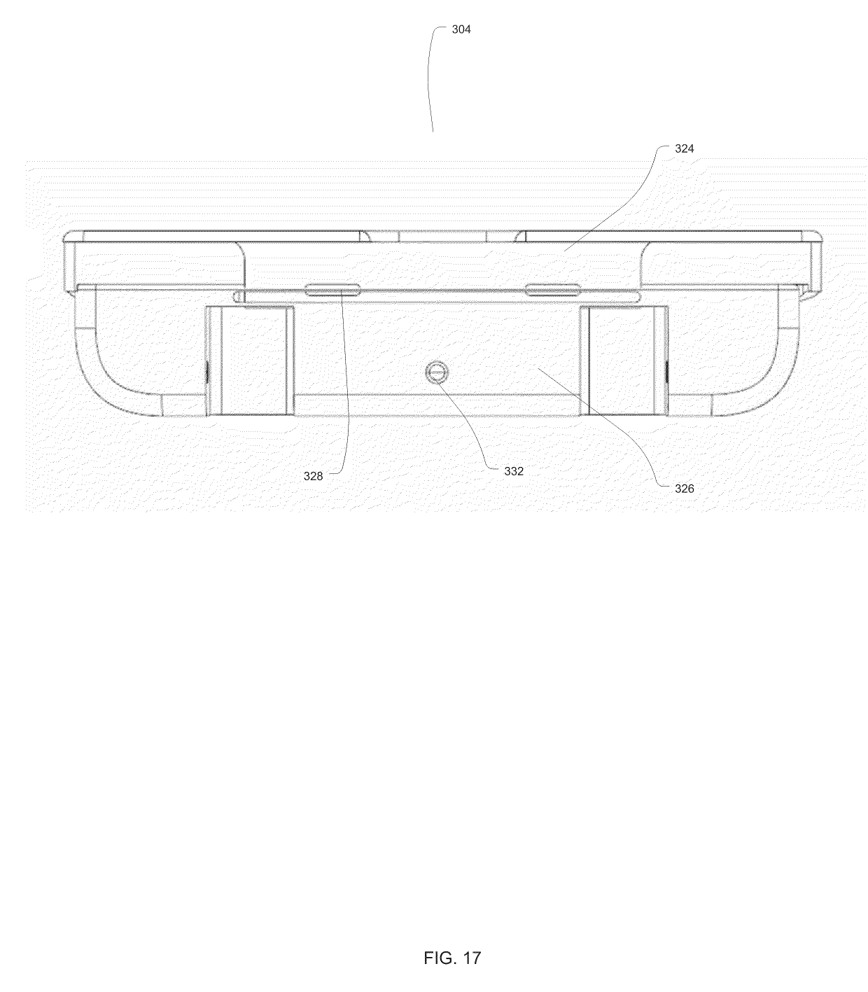

FIG. 17 illustrates a vehicle side view of a floorboard. An embodiment of a floorboard 304 may comprise a lid portion 324 and a container portion 326. The container portion 326 provides a volume for storage while the lid portion 324 substantially covers the volume and therefore covers and retains any items stored in the floorboard 304. The floorboard 304 may further comprise hinge 328. The hinge 328 may be hidden so as not to be tampered with. The hinge 328 could also allow the lid portion 324 to be removed from the container portion 326 with out the use of tools. The container portion may also comprise mounting structures such as the fastener opening.

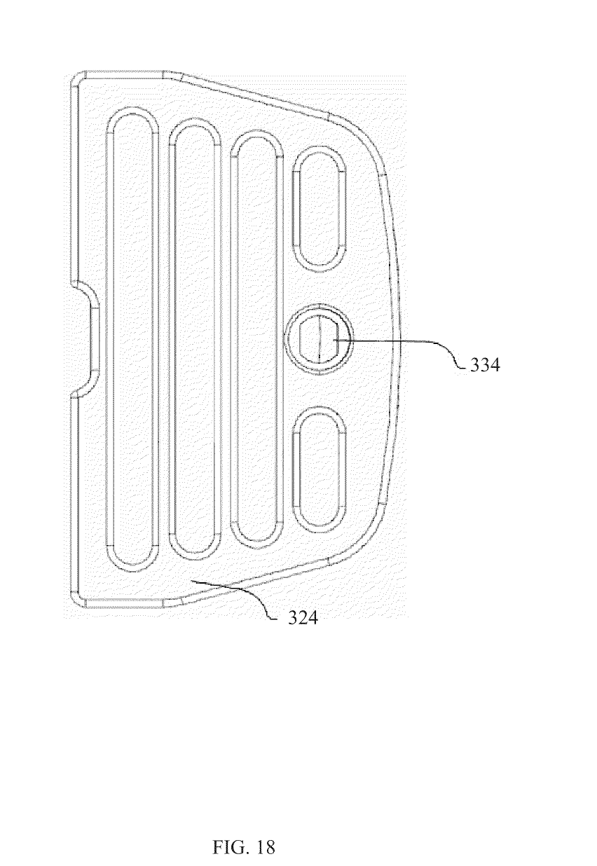

FIG. 18 illustrates a floorboard 304 providing greater detail of the top of the lid portion 324. As can be seen in the figure the lid portion 324 may comprise a textured portion thereon. The lid portion may also comprise a lock opening 334 for accommodating a lock.

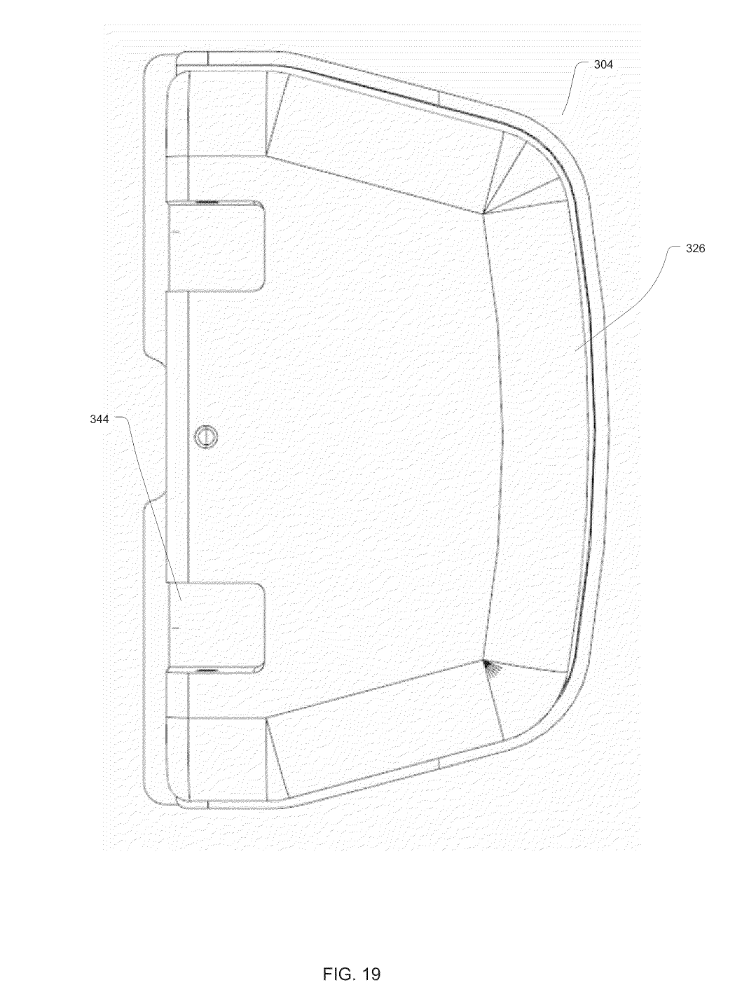

FIG. 19 illustrates a bottom view of a floorboard. As can be seen in the figure floorboard 304 may have mounting structures 344 or recesses therein for accepting a mounting bracket.

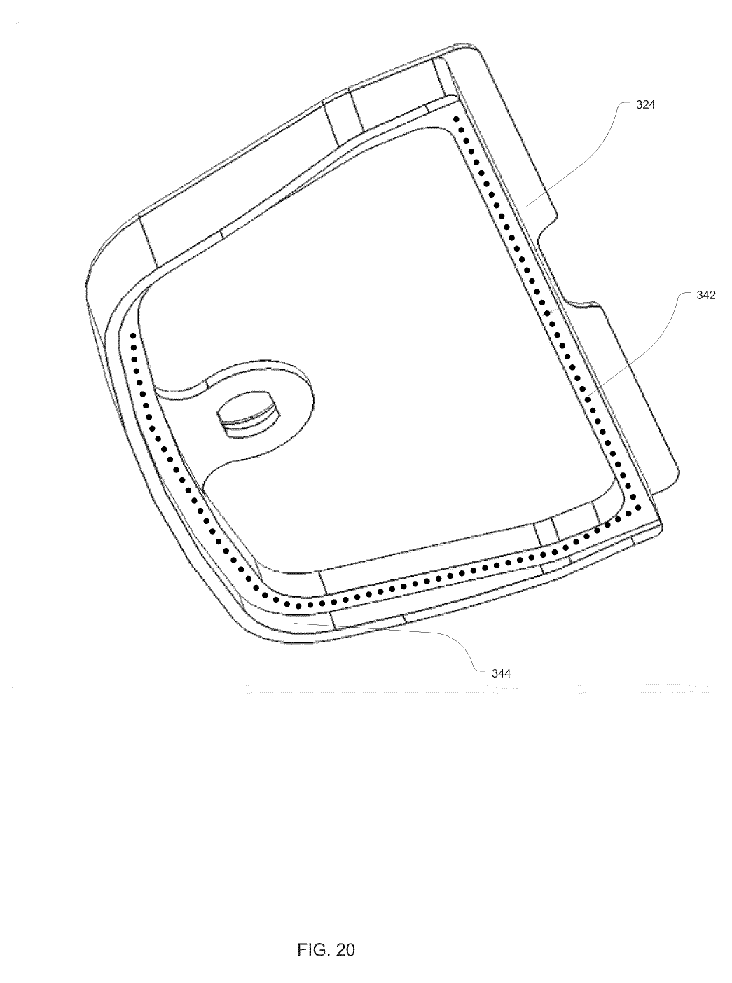

FIG. 20 illustrates an inside detailed view of a a lid portion 324 of a floorboard 304. As can be seen in the figure the interior of the lid portion 324 may comprise a lip 346 for covering the top of a corresponding container portion. A seal may be disposed on the lip portion. In an embodiment a seal 342 may be used to provide further weather tightness. The seal may be made of any suitable material and may be attached to either the lid portion or the container portion 326. The seal may be made of a deformable material to accommodate contours of the mating parts.

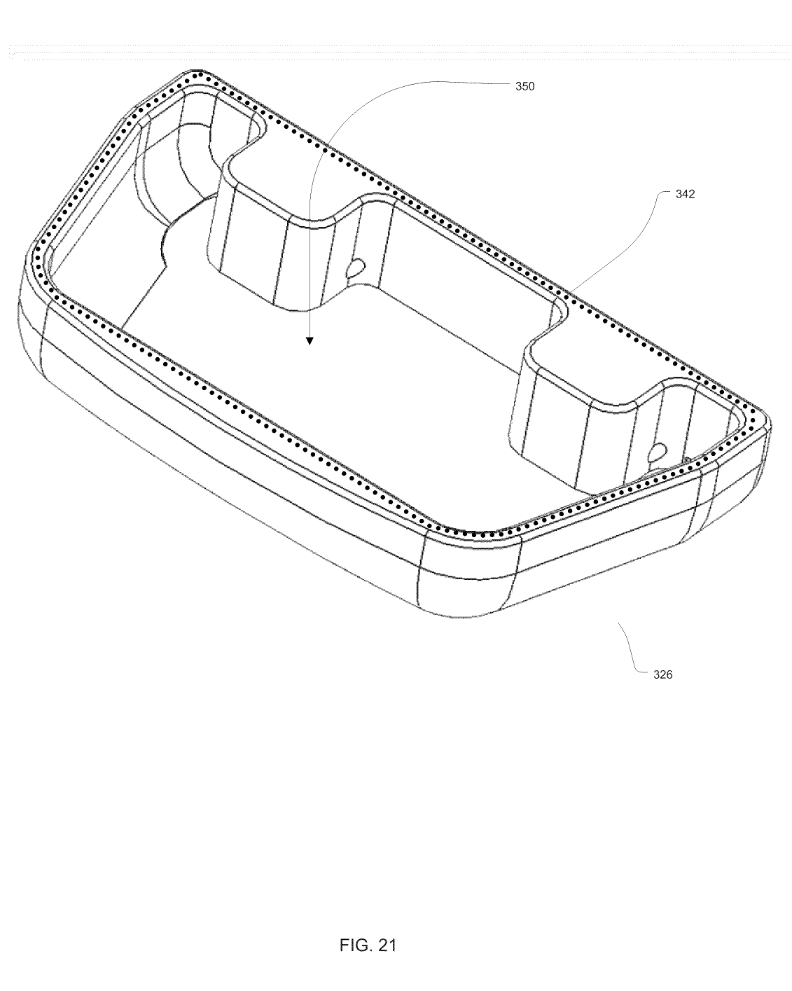

FIG. 21 illustrates an inside detailed view an embodiment of a container portion 326. As can be seen in the figure, an interior volume 350 is available for storage space. A seal 342 may be attached to the container portion 326 of a floorboard 304. The seal may be made of any suitable material and may be attached to either the lid portion or the container portion 326. The seal may be made of a deformable material to accommodate contours of the mating parts.

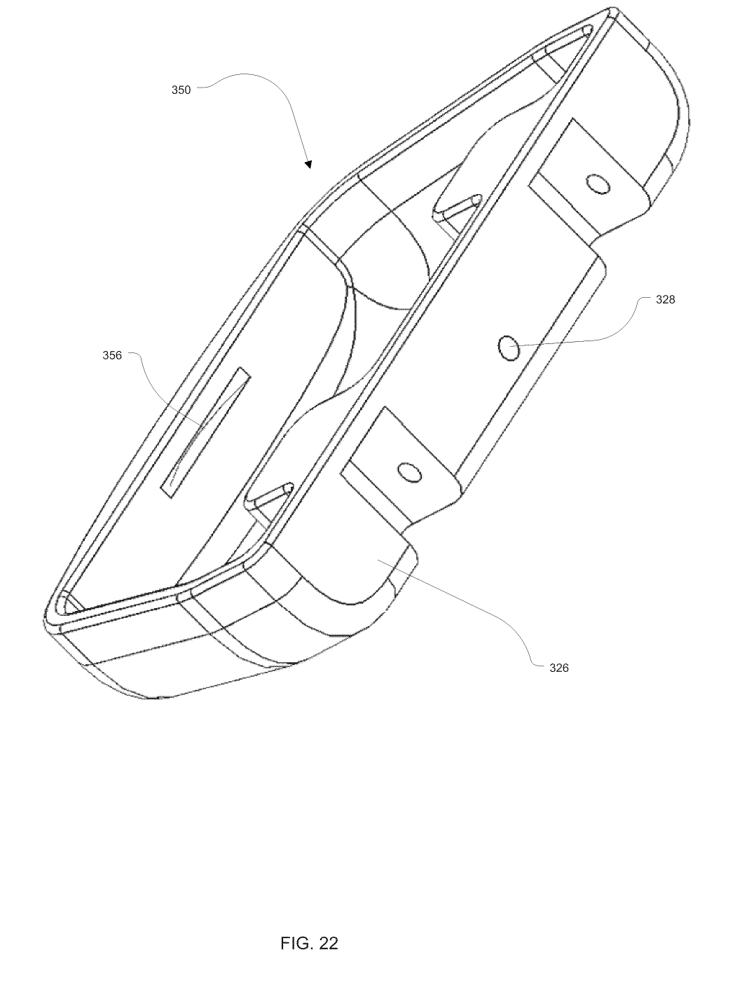

FIG. 22 illustrates a vehicle side view of a container portion 326. The container portion 326 provides a volume 350 for storage. The container portion 326 may also comprise mounting structures such as the fastener opening 328. As seen in the figure a locking structure 356 may be disposed therein to receive a portion of a locking device, such as a locking arm of a barrel lock.

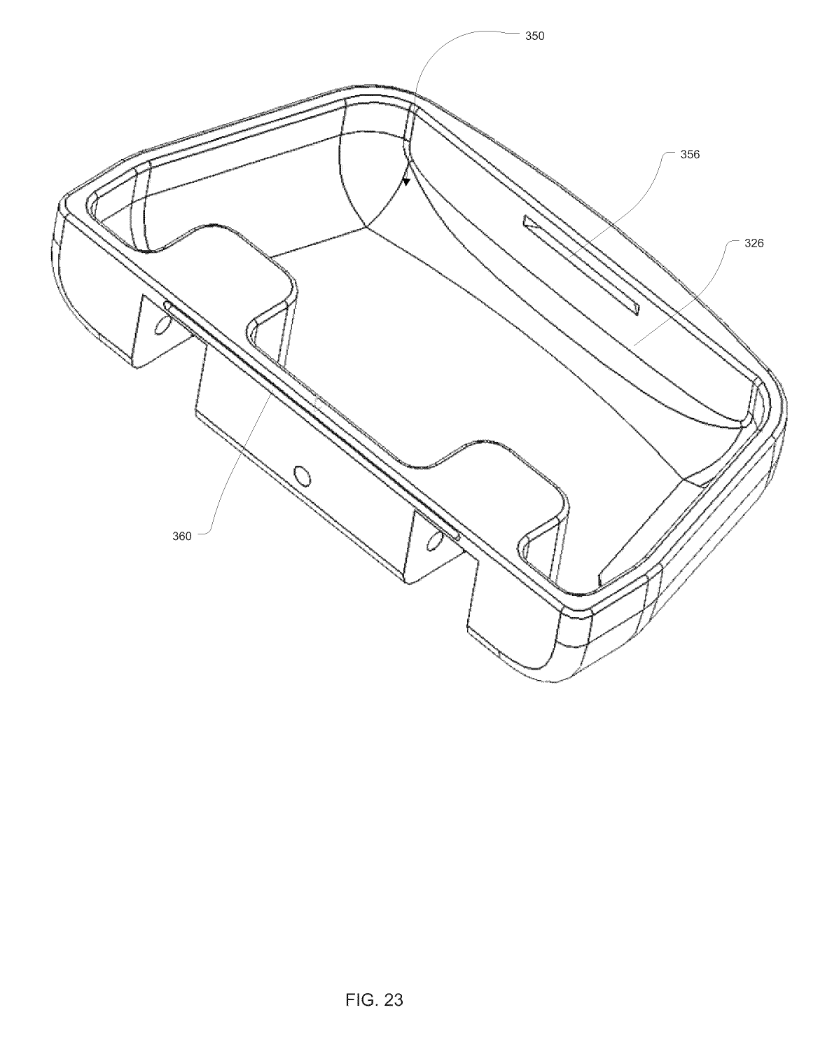

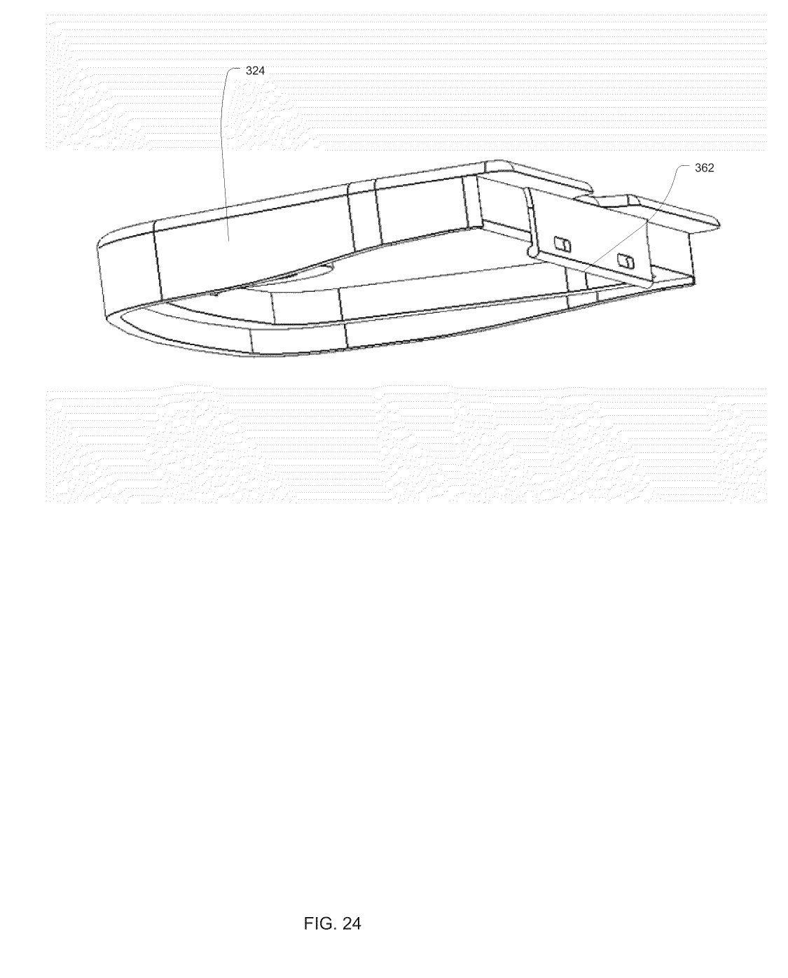

FIG. 23 illustrates a vehicle side view of a container portion 326 having a hidden hinge recess 360. The hidden hinge recess 360 may be configured to allow a corresponding hinge component to rotate therein and also may be configured to all the corresponding hinge component to slide coaxially therein. In use if the hinge components are slide relative to each other the lid portion may be separated from the base without the use of tools. The container portion 326 provides a volume 350 for storage. The container portion 326 may also comprise mounting structures such as the fastener opening 328. As seen in the figure a locking structure 356 may be disposed therein to receive a portion of a locking device, such as a locking arm of a barrel lock. FIG. 24 illustrates an inside detailed view of a lid portion 324 having a easy detach hinge embodiment corresponding to the embodiment of FIG. 23. As can be seen in the figure lid portion 324 comprises protruding hinge component 362 that corresponds to the hinge recess 360 of the preceding figure. The hidden hinge recess 360 may be configured to allow a corresponding hinge component to rotate therein and also may be configured to all the corresponding hinge component to slide coaxially therein. In use if the hinge components are slide relative to each other the lid portion may be separated from the base without the use of tools.

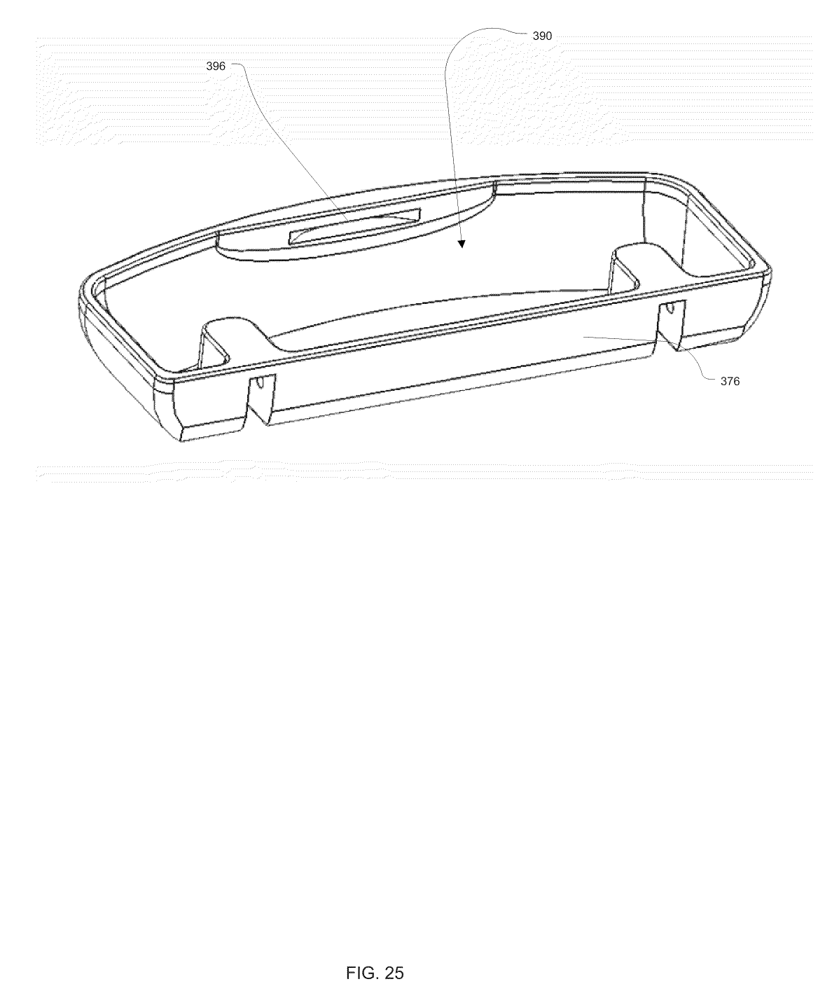

FIG. 25 illustrates a vehicle side view of a container portion 376 of a larger floorboard 302. The container portion 376 provides a volume 390 for storage. As seen in the figure a locking structure 396 may be disposed therein to receive a portion of a locking device, such as a locking arm of a barrel lock.

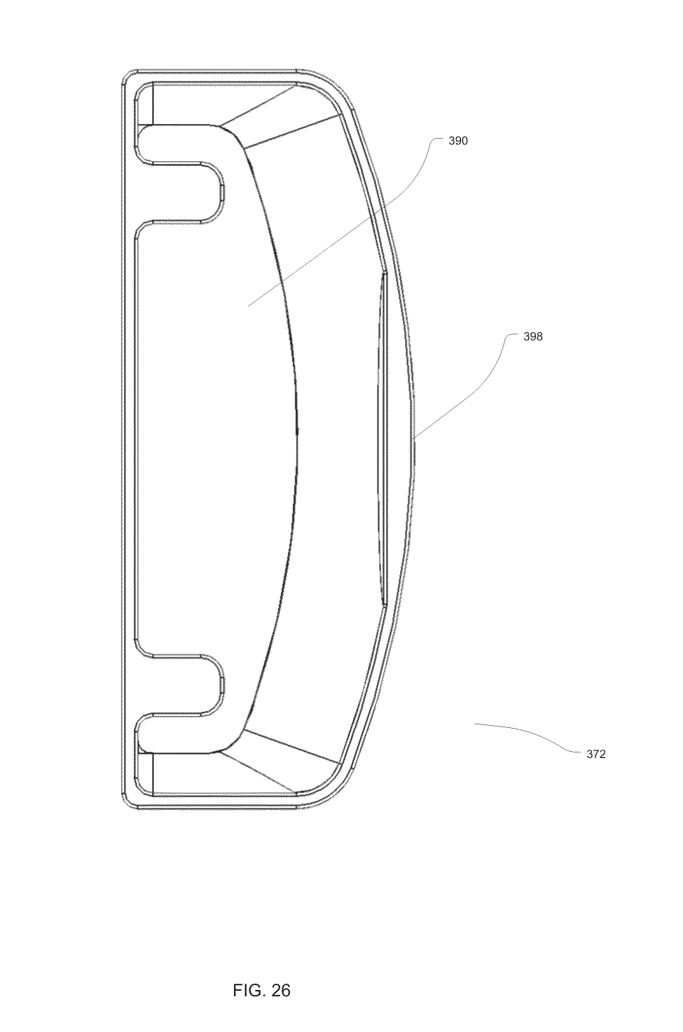

FIG. 26 illustrates a top view of a container portion 376 of a larger floorboard 302. The container portion 376 provides a volume 390 for storage. As seen in the figure, the container portion 376 may be tapered toward the outside edge 398 to allow for additional lean angle, while still allowing for a large and supportive top surface area.

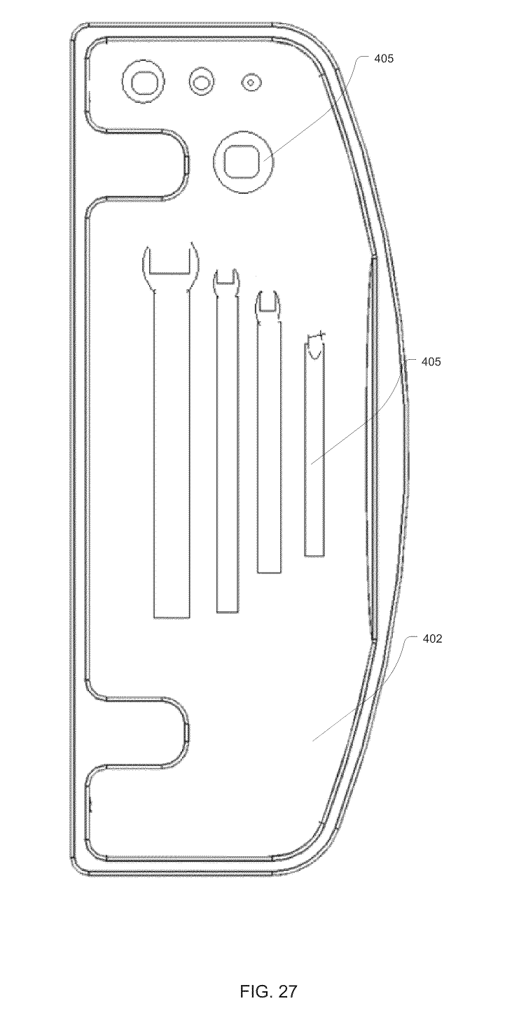

FIG. 27 illustrates an inside detailed view of a floorboard having an insert 402. An insert may be used inside of a floorboard to organize and protect items held therein. As can be seen in the figure, various tools 405 are held in the instant insert 402. Other configurations are intended to be within the scope of this disclosure. A kit may be assembled with vehicle specific tools such that when a user uses the floorboard from a kit it contains the proper tools for the vehicle it is mounted to.

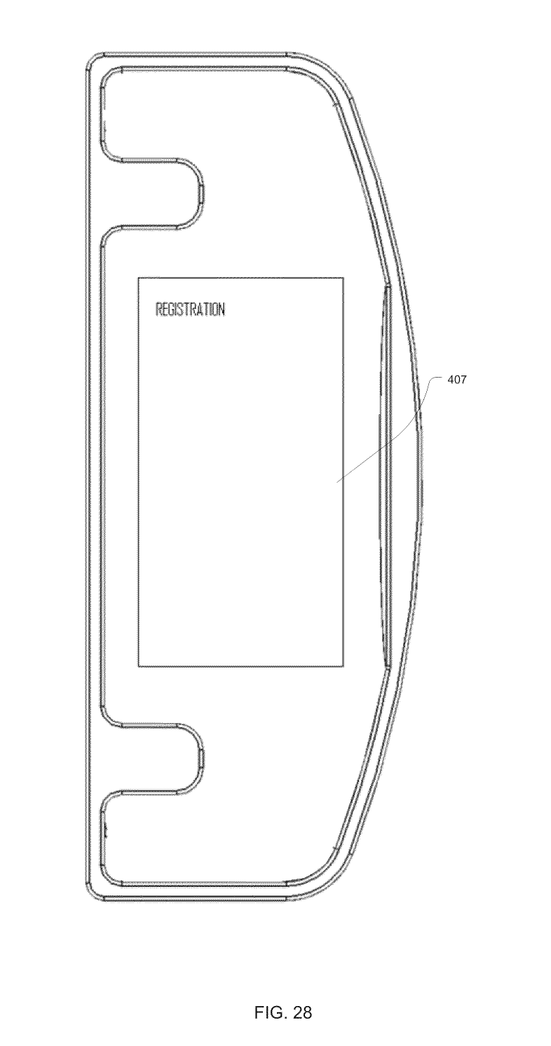

FIG. 28 illustrates an inside detailed view of a floorboard having an insert to hold documents such as vehicle registration and ownership records 407.

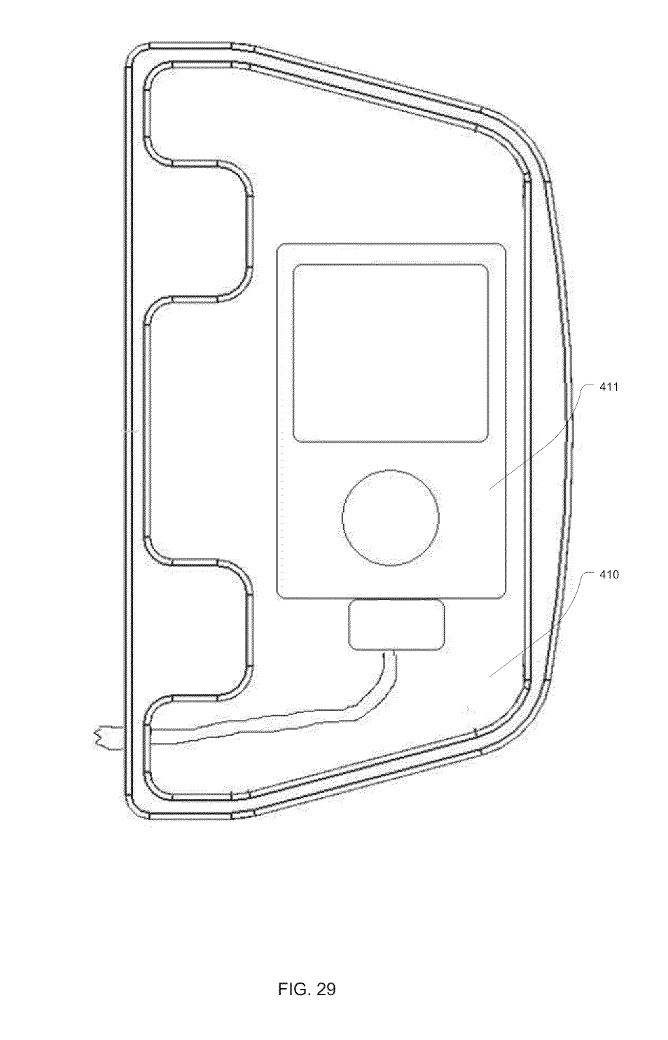

FIG. 29 illustrates an inside detailed view of a floorboard having an insert 410 configured to secure an electronic device 411 therein. In an embodiment a floorboard my provided electronic connectivity to a device 411 thereby allowing the device to charge and be used while stowed. Examples of commonly used electronic devices comprise; music players, intercoms, radios, phones, and gps devices. While stowed the electronic device may be accessed wirelessly or wired.

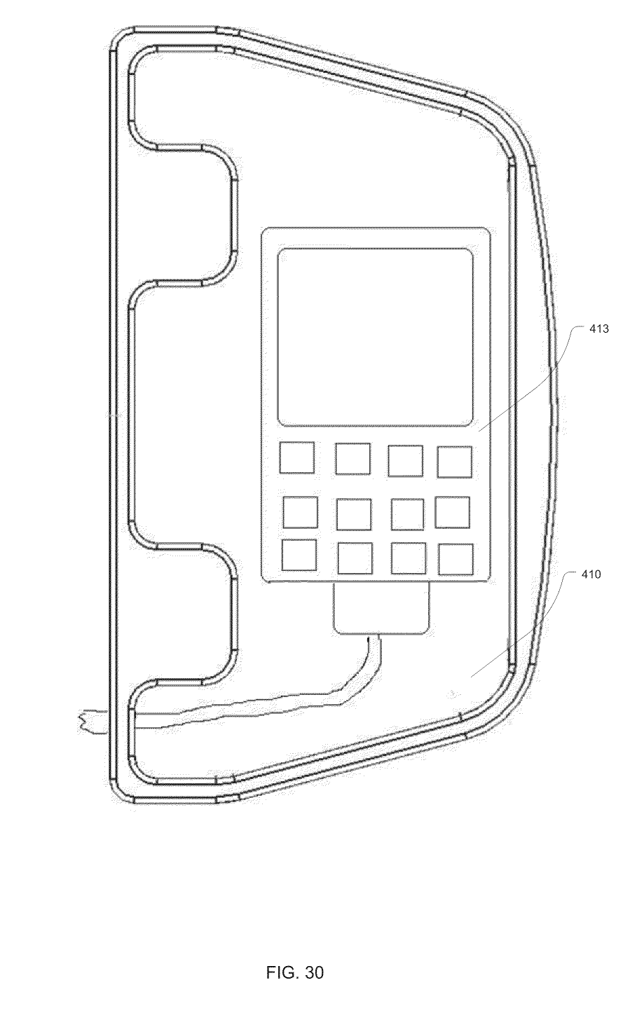

FIG. 30 illustrates an inside detailed view of a floorboard providing electrical connectivity with a cell phone 413 therein.

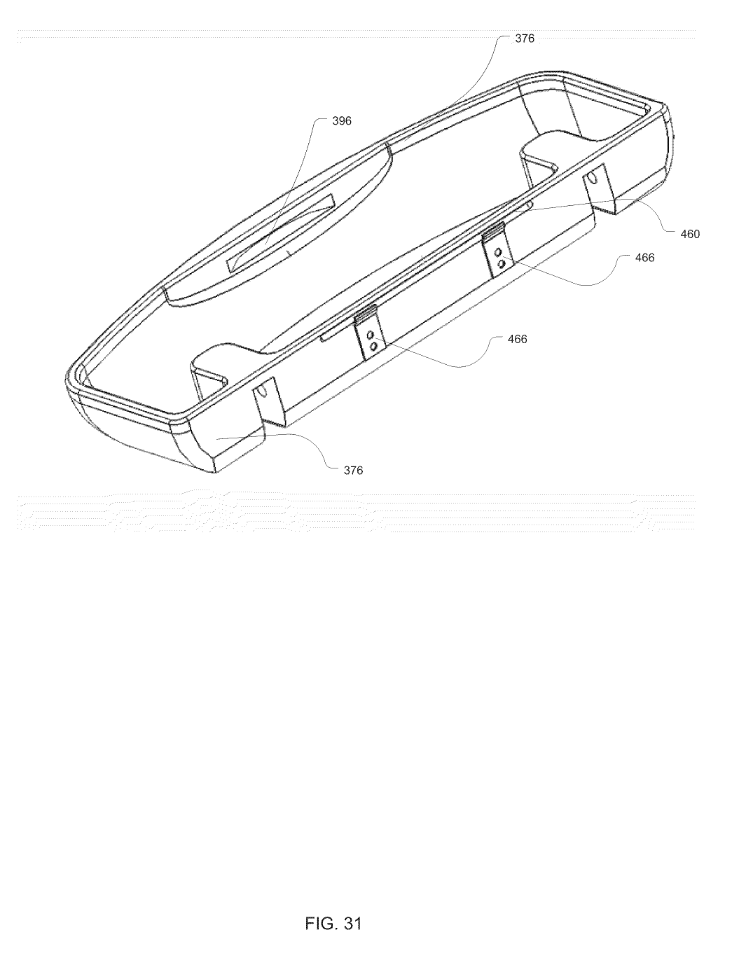

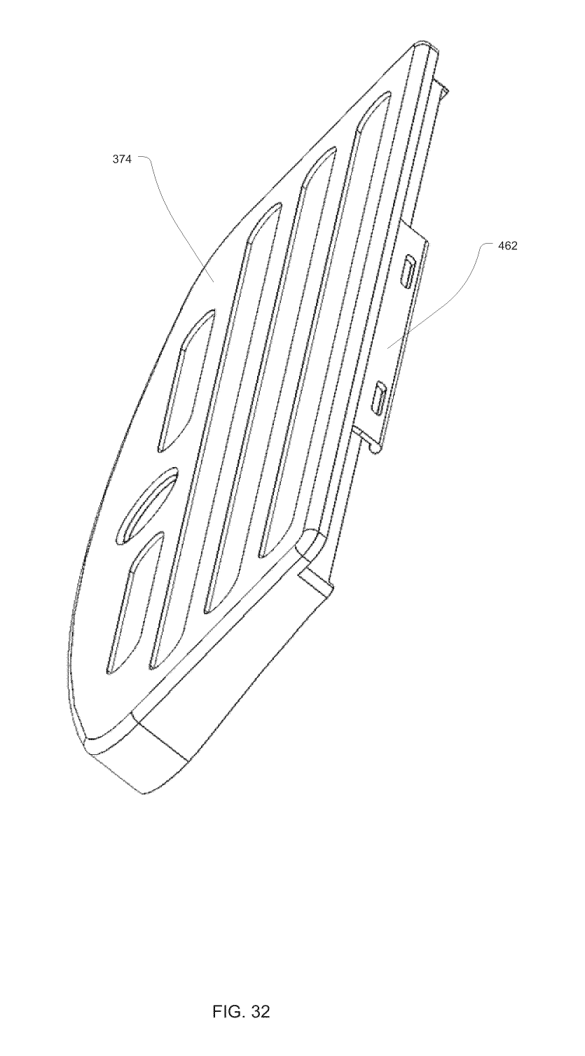

FIG. 31 illustrates a vehicle side view of a container portion 376 having a hidden hinge recess 460. The hidden hinge recess 460 may be configured to allow a corresponding hinge component to rotate therein and also may be configured to all the corresponding hinge component to slide coaxially therein. In use if the hinge components are slide relative to each other the lid portion may be separated from the base without the use of tools. The container portion 376 provides a volume 390 for storage. As seen in the figure a locking structure 396 may be disposed therein to receive a portion of a locking device, such as a locking arm of a barrel lock. As can be seen in the figure, the hinge mechanism may further include resilient spring members 466 that assist in holding the hinge mechanism together. FIG. 32 illustrates an inside detailed view of a lid portion 374 having an easy detach hinge embodiment corresponding to the embodiment of FIG. 31. As can be seen in the figure, lid portion 374 comprises protruding hinge component 462 that corresponds to the hinge recess 460 of the preceding figure. The hidden hinge recess 460 may be configured to allow a corresponding hinge component to rotate therein and also may be configured to allow the corresponding hinge component to slide coaxially therein. In use if the hinge components are slide relative to each other the lid portion may be separated from the base without the use of tools.

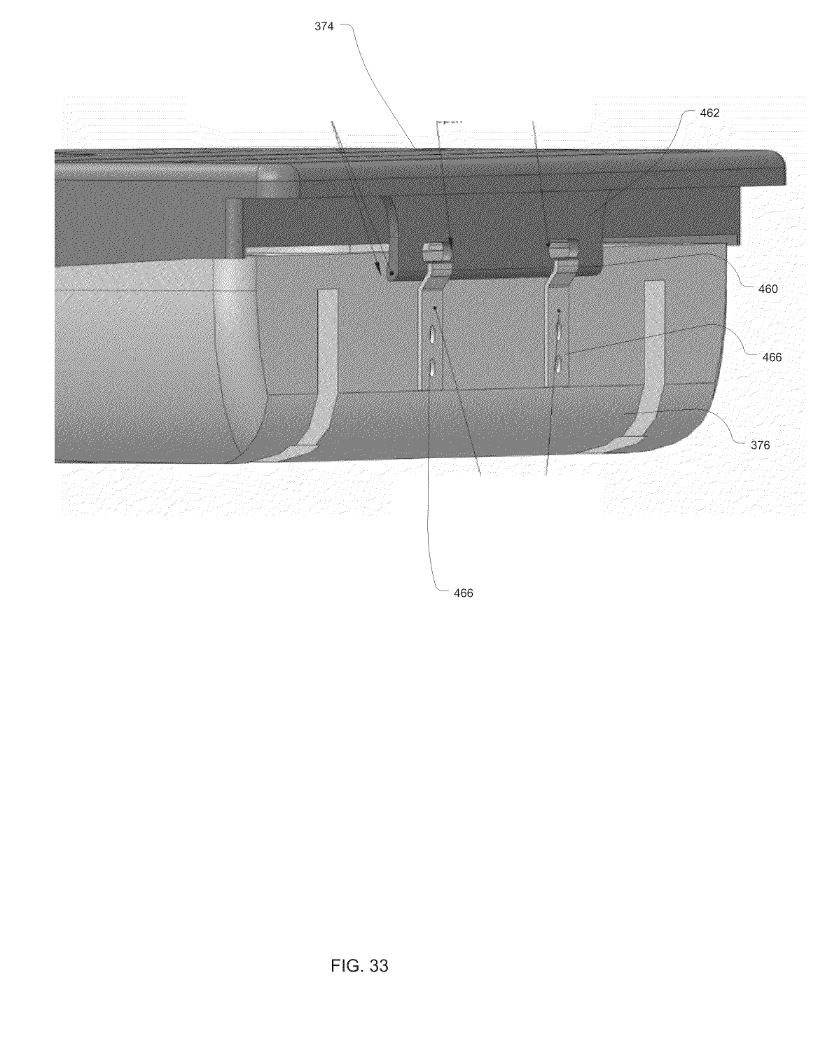

FIG. 33 illustrates an embodiment of a floorboard having a releasable hinges shown in greater detail. The hidden hinge recess 460 may be configured to allow a corresponding hinge component to rotate therein and also may be configured to all the corresponding hinge component to slide coaxially therein. In use if the hinge components are slide relative to each other the lid portion may be separated from the base without the use of tools. As can be seen in the figure, the hinge mechanism may further include resilient spring members 466 that assist in holding the hinge mechanism together. FIG. 32 illustrates an inside detailed view of a lid portion 374 having an easy detach hinge embodiment. As can be seen in the figure, lid portion 374 comprises protruding hinge component 462 that corresponds to the hinge recess 460 of the preceding figure. The hidden hinge recess 460 may be configured to allow a corresponding hinge component to rotate therein and also may be configured to allow the corresponding hinge components to slide coaxially therein. In use if the hinge components are slide relative to each other the lid portion may be separated from the base without the use of tools.

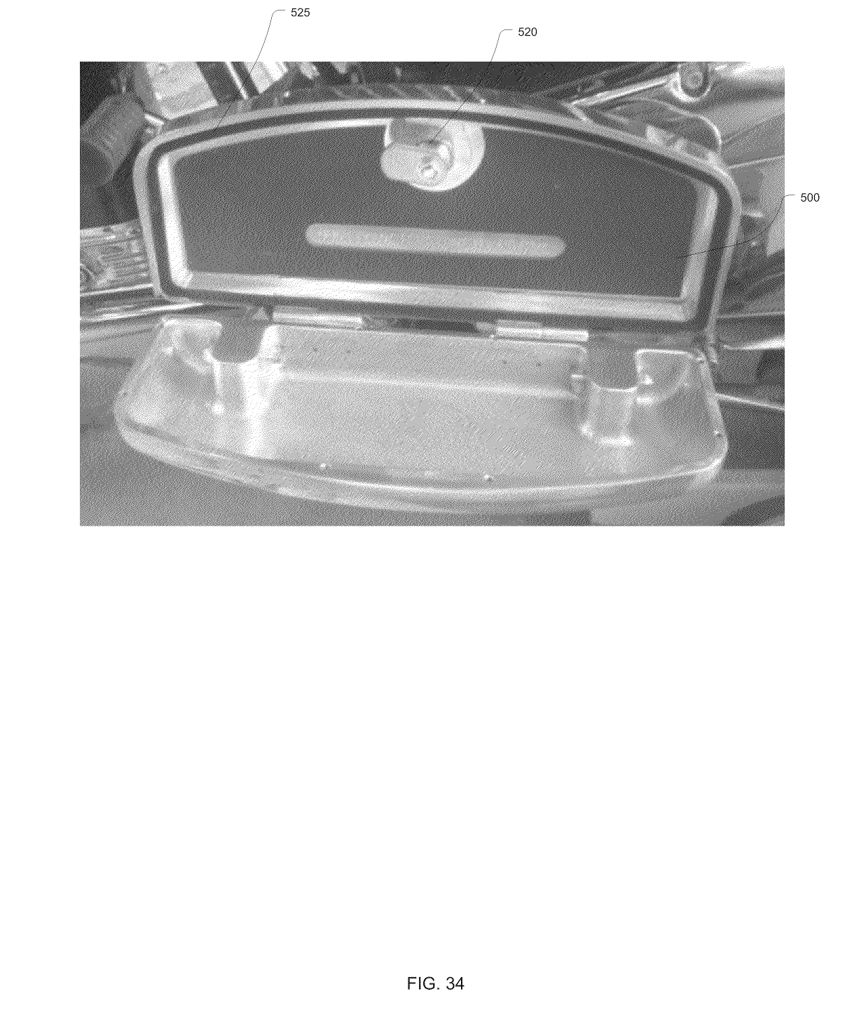

FIG. 34 illustrates an embodiment of a floorboard having a magnetic lid insert 500. The magnetic lid insert may be used to hold tools and parts when tending to a vehicle. As discussed previously the lid portion of a floorboard may be removed from the container portion and used as a tool tray. Also illustrated in the figure is a barrel locking mechanism 520 for use with the locking structures discussed above. As discussed in more detail above, a seal 525 is also shown in the figure and is shown attached to the lid portion of the illustrated floorboard.

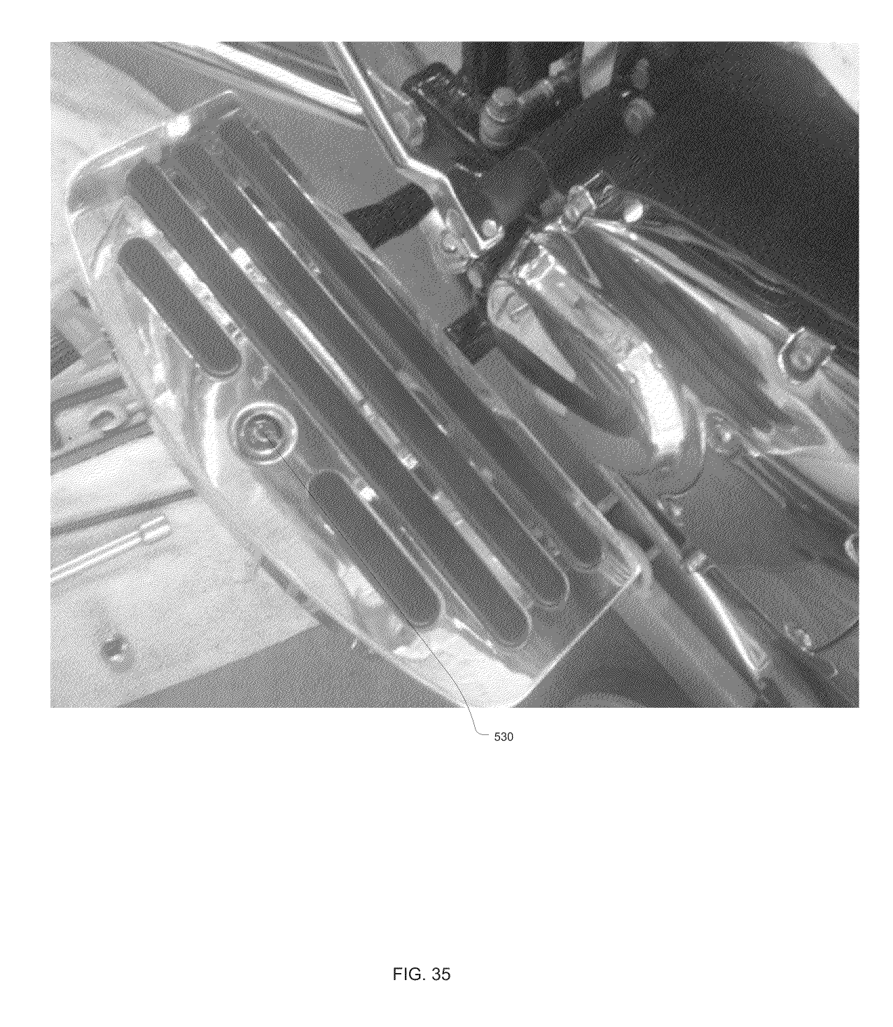

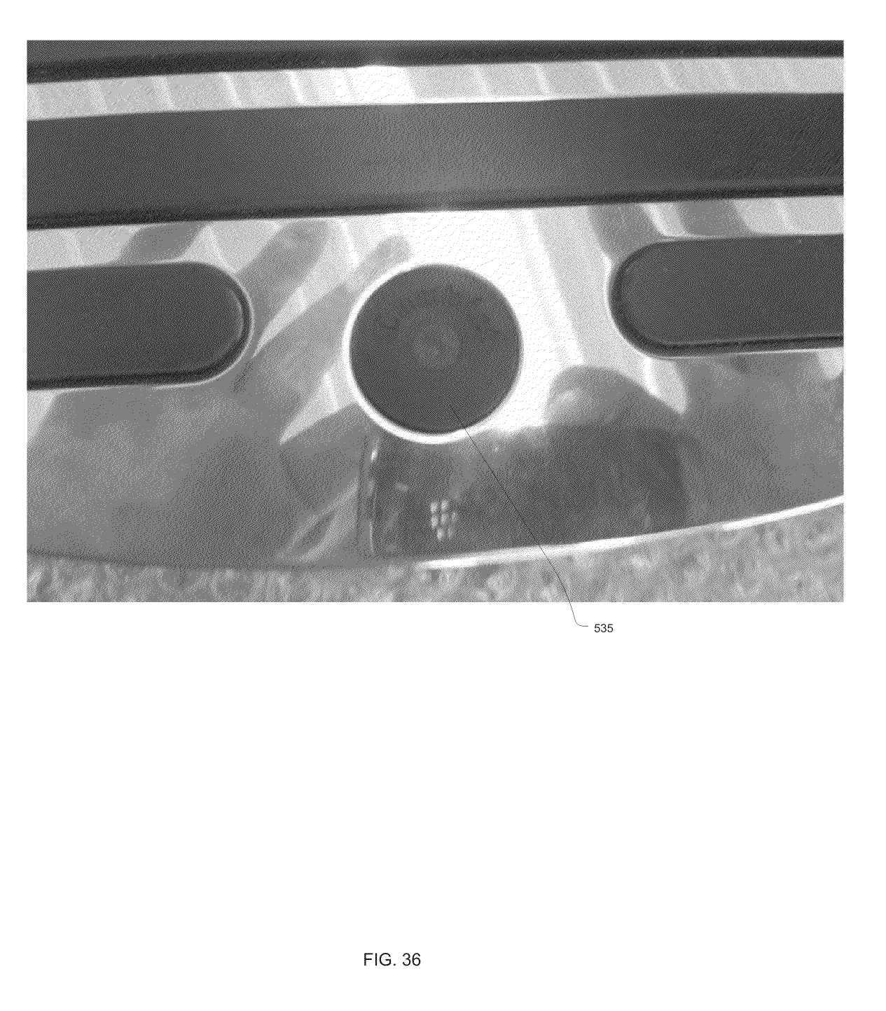

FIG. 35 and FIG. 36 illustrate the inclusion of a barrel lock 530 in an embodiment. Because floorboards are likely to attract dirt and grime from a riders foot a cap that covers and conceals the key opening of the lock, a cover 535 may be employed to protect the lock as illustrated in FIG. 36.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A floorboard for exterior mounting on a vehicle comprising:
a container portion comprising an interior volume configured for storage;
a lid portion sized and shaped to cover said container portion;
wherein said lid portion further comprises a substantially flat surface that is configured to support a user's foot; and
a bracket for mounting to a vehicle.

2. The floorboard of claim 1, wherein the container portion is pivotally connected to the lid portion, such that the lid portion is rotatable relative to the container portion thereby providing access to the interior volume of the floorboard.

3. The floorboard of claim 1, wherein the lid portion is removably attached to the container portion, such that the lid portion is removable from the container portion thereby providing access to the interior volume of the floorboard.

4. The floorboard of claim 1, wherein the lid portion is removably and pivotally attached to the container portion, such that the lid portion is removable and rotatable relative to the container portion thereby providing access to the interior volume of the floorboard.

5. The floorboard of claim 1, wherein the bracket is attached to the container portion with a fastener that is operable from inside of the container portion.

6. The floorboard of claim 1, further comprising a magnet associated with said lid portion for magnetically attracting tools and parts thereto.

7. The floorboard of claim 1, further comprising a weather tight seal, sealing the lid portion and the container portion.

8. The floorboard of claim 1, further comprising a lock, for locking the lid portion and the container portion.

9. The floorboard of claim 1, further comprising an insert for holding items in place within the container portion.

10. The floorboard of claim 9, wherein said insert comprises recesses therein configured to accommodate electronic devices therein.

11. The floorboard of claim 1, further comprising an opening therein for allowing electrical wiring to pass therethrough.

12. The floorboard of claim 1, further comprising electrical connectivity.

13. The floorboard of claim 8, wherein the lock is keyed so as to operable with a key the operates said vehicle upon which the floorboard is attached.

14. The floorboard of claim 1, further comprising a hidden hinge connecting said lid portion to said container portion such that the hinge can only be accessed from within said container portion.

15. The floorboard of claim 1, further comprising a tool therein corresponding to the vehicle upon which the floorboard is attached.

16. The floorboard of claim 8, further comprising a cover for concealing and protecting an opening of said lock.

17. A floorboard kit for exterior mounting on a vehicle comprising:
a pair of floorboards wherein each floorboard comprises:
a container portion comprising an interior volume configured for storage;
a lid portion sized and shaped to cover said container portion;
wherein said lid portion further comprises a substantially flat surface that is configured to support a user's foot;
a bracket for mounting to a vehicle;
a plurality of removable inserts.

18. The floorboard kit of claim 17, further comprising a plurality of tools corresponding to the vehicle upon which the floorboards are mounted.

19. The floorboard kit of claim 17, wherein the removable inserts are customizable by a user.

21. The floorboard kit of claim 17, wherein the container portion is pivotally connected to the lid portion, such that the lid portion is rotatable relative to the container portion thereby providing access to the interior volume of the floorboard.

22. The floorboard kit of claim 17, wherein the lid portion is removably attached to the container portion, such that the lid portion is removable from the container portion thereby providing access to the interior volume of the floorboard.

23. The floorboard kit of claim 17, wherein the lid portion is removably and pivotally attached to the container portion, such that the lid portion is removable and rotatable relative to the container portion thereby providing access to the interior volume of the floorboard.

24. The floorboard kit of claim 17, wherein the bracket is attached to the container portion with a fastener that is operable from inside of the container portion.

25. The floorboard kit of claim 17, further comprising a magnet associated with said lid portion for magnetically attracting tools and parts thereto.

26. The floorboard kit of claim 17, further comprising a weather tight seal, sealing the lid portion and the container portion.

27. The floorboard kit of claim 17, further comprising a lock, for locking the lid portion and the container portion.

28. The floorboard kit of claim 17, further comprising an insert for holding items in place within the container portion.

29. The floorboard of claim 28, wherein said insert comprises recesses therein configured to accommodate electronic devices therein.

30. The floorboard kit of claim 17, further comprising an opening therein for allowing electrical wiring to pass therethrough.

31. The floorboard kit of claim 17, further comprising electrical connectivity.

32. The floorboard of claim 27, wherein the lock is keyed so as to operable with a key the operates said vehicle upon which the floorboard is attached.

33. The floorboard kit of claim 17, further comprising a hidden hinge connecting said lid portion to said container portion such that the hinge can only be accessed from within said container portion.

34. The floorboard kit of claim 17, further comprising a tool therein corresponding to the vehicle upon which the floorboard is attached.

35. A floorboard for exterior mounting on a vehicle comprising:
a container portion comprising an interior volume configured for storage;
a lid portion sized and shaped to cover said container portion;
wherein said lid portion further comprises a substantially flat surface that is configured to support a user's foot; and
a bracket for mounting to a vehicle;
a weather tight seal disposed between the lid portion and the container portion, such that said weather tight seal seals the interior volume of the container portion from moisture and debris.
